(19) United States
(12) Patent Application Publication
(10) Pub. No.: US 2003/0151676 A1
(43) Pub. Date: Aug. 14, 2003

(54) Input apparatus for image

(76) Inventors: Kazuyuki Seki, Tokyo (JP); Takaho Koshiishi, Tokyo (JP); Keiichi Suzuki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/330,349

(22) Filed: Dec. 30, 2002

(30) Foreign Application Priority Data
Dec. 28, 2001 (JP) 2001-402067

(51) Int. Cl. H04N 5/222

(52) U.S. Cl. 348/231.3; 348/231.4; 348/333.02

(57) ABSTRACT

An input apparatus for image according to the present invention can be set to a digital camera in a simplified manner without requiring program transfer, and can simply set operations of various input modes and operation procedures, and further can improve operation property.

A format list prepared in an external apparatus is inputted into a main control section (104) through an I/F section (107), and is recorded in a recording section (105). A processing section (131) in the main control section (104) analyzes the format list, and automatically changes to an input mode indicated by a tag for inputting in the order of description to allow a user to input necessary information. An operator ensures an operation for inputting corresponding to each input mode following a request only by performing the operation for inputting for an operation section (106). The format list completed with the operation for inputting can be transmitted to an external apparatus through the I/F section (107). The external apparatus can obtain requiring input data following the format list after the completion thereof.

### BACKGROUND OF THE INVENTION

1. Field or the Invention

The present invention relates to an input apparatus for image for inputting varieties of multimedia, and more specifically to an input apparatus for image capable of simply achieving an input operation operable in a plurality of input modes such as photographing for a still image, recording for a voice, photographing for an animation, inputting for a character, etc., in a digital camera apparatus, etc., operable in those input modes.

2. Description of the Prior Art

A prototype of a digital camera is an electronic still camera, which has been put into practical use since about 1981. Thereafter, owing to facts that a photographing device CCD has been made highly fine and made inexpensive, and a recording medium card memory has had a large capacity and has been miniaturized, and a semiconductor chip of still image compression encoding type JPEG appears, the prototype has been developed to a present smaller, more inexpensive, higher performance digital camera.

An environment for use of any instrument in the course of the movement of a user has been arranged following the rapid spread of a cellular phone, miniaturization of a notebook PC, and the spread of a PDA. Under such an environment a digital camera, which has been spread as image input means, is coupled to a personal computer and a network, and is becoming an important component of a multi-media system as a capture for not only images but also for all image information such as voices and animations.

Further, the digital camera is an apparatus anticipated together with portable telephones, PDA, and palm top PC as a candidate of computers (wearable computers) possessed by users, studies for which have been activated, simply irrespective of a capturing function of image information, and it is desired to have higher functions such as a connection function with the Internet, an individual personal information control function, and a presentation function

In prior art, a program development language for use in a digital camera such as the digital script available from Flash Point company has been presented. Use of the Digital script realizes the following functions.

a. Camera operation can be simplified.

Simplification of a plurality of operations by the script.

Automation of a repeating work (representing a routine work in the form of a script).

b. Camera operation can be customized.

C. Photographing can be simplified.

Photographing according to the conditions of photographing provided in the form of procedures (forgot photographing and forgot setting for parameters can be prevented.).

d. Necessary data can be prepared with a working application on a PC.

Preparation of the home page (HTML document) including a reference to a text and an image file.

Preparation of data transferred to an image application on a PC in the form of a text file.

A digital camera disclosed in Japanese Laid-Open Patent Publication No. Hei 10-341396 (Title: A method of attaching a function of a digital camera and a digital camera, Applicant: Seiko Epson) realizes a desired function by incorporating a program with a required function into the digital camera from the outside.

The prior art technique however prepares a program outside a digital camera, and incorporates the program into the camera to obtain a desired function. It is herein necessary to transfer the whole of the program every alteration of the function of the camera in order to incorporate the program itself into the camera together with the requirement of a predetermined capacity of a memory area for storage of the program in the digital camera.

Although there is recently ensured an input operation in a plurality of input modes such as those of recording of a voice, photographing, of an animation, inputting of a character, inputting of a text without limitation to photographing of a still picture owing to expansion of the function of a digital camera, there is earnestly desired the function of arranging varieties of these input modes and of inputting them. There was, in the prior art, no function capable of outputting varieties of input data available with a series or operations in a predetermined format to an external personal computer.

SUMMARY OF THE INVENTION

To solve the problems with the aforementioned prior art techniques, it is an object of the present invention to provide an input apparatus for image in which no program transfer is required, together with assurance of setting of functions of a digital camera in a simplified fashion, and operations in various input modes and operation procedures can be set simply, and hence operation properties can be improved.

To solve the aforementioned problems with the prior art and achieve the foregoing object of the present invention, an input apparatus for image in accordance with a first aspect of the present invention comprises: recording means for incorporating and recording a format list in which there are described the procedures of an operation for inputting employing selectively a plurality of input functions possessed by the input apparatus for image previously in an external apparatus such as a personal computer and the like; processing means for analyzing the described contents in the incorporated format list, selecting an input function corresponding to an analyzed result to transfer it to a corresponding input mode, and displaying and outputting the contents of an input operation in the foregoing input mode; display means for displaying the foregoing selected input mode; and operation means for executing the operation of inputting data based upon the input mode displayed on the display means.

In accordance with the first aspect of the present invention, the contents of the operation of inputting in the input mode in conformity with a request prepared by an external apparatus are displayed, with which display an input operation in a proper input mode can be executed to improve an operation property. Further, since the processing is to incorporate and analyze the format list, program transfer is unnecessary accordingly without requiring a memory capacity.

An input apparatus for image in accordance with a second aspect of the present invention is adapted in the present invention in accordance with the first aspect such that the foregoing plurality of the input functions are inputs for a still picture, a voice, an animation, and a character, and that the foregoing processing means changes to a relevant input mode among the photographing of a still image, recording of a voice, photographing of an animation, and inputting a text corresponding to the selected input function to display and output the input mode to the foregoing display means and execute the operation of inputting data in the input node.

In accordance with the second aspect of the present invention, each input mode is displayed on the display means, so that a series of the input processings can be completed only by executing the input operation following to instructions.

An input apparatus for image in accordance with a third aspect of the present invention is adapted in the present invention in accordance with the second aspect such that the foregoing processing means updates and records data obtained by the operation of inputting in the foregoing changed input mode related to a corresponding described position in the recorded format list in the foregoing recording means.

In accordance with the third aspect of the present invention, input data is related to the position of description on the format list by executing the instructed operation of inputting, so that input data inputted in each input mode can be arranged in series in the form of the description of the format list.

An input apparatus for image according to a fourth aspect of the present invention is adapted in the present invention in accordance with the third aspect of the present invention such that the foregoing processing means relates to attached information such as the conditions of recording of data obtained with the operation of inputting in said changed input mode, and the attributes of a file with the foregoing data to update and record the foregoing format list.

In accordance with the fourth aspect of the present invention, attached information such as the conditions of recording of data and the attribute of a file is related, so that more detailed information can be recorded for the use for control, etc.

An input apparatus for image in accordance with a fifth aspect of the present invention is adapted in the present invention in accordance with the third aspect such that in the foregoing recording means data such as images and characters concerning attributes of the apparatus and a user can be inputted and stored, and the foregoing processing means analyzes the contents of the description of the foregoing incorporated format list, selects an input function corresponding to an analyzed result to change the operation to a corresponding input mode, and displays and outputs the operation of inputting in the foregoing input mode, and further when the description contents of the format list indicate an input of the attributes of said stored apparatus and a user, reads the attribute data of the apparatus and the user from the foregoing recording means, and writes it at a corresponding description position and updates and records the foregoing format list.

In accordance with the fifth aspect of the present invention, the attributes of the apparatus and a user can be incorporated into the format list and updated, and the need of any specific operation is eliminated, whereby more detailed information can be described in the format list to improve the convenience of the control and the like.

An input apparatus for image in accordance with a sixth aspect of the present invention is adapted in the present invention in accordance with any one among the first to fifth aspects of the present invention such that the foregoing format list is described in the form of an HTML having a plurality of tags for inputting, and the foregoing processing means analyzes the contents of the description of the corresponding tag for inputting described in the foregoing format list, and selects an input function corresponding to an analyzed result to transfer the operation to a corresponding input mode, and further displays and outputs an operation of inputting in said input mode and describes data inputted in said input mode with a corresponding tag for inputting of the format list in the form of the HTML.

In accordance with the sixth aspect of the present invention, a generalized form of the HTML can be employed for the format list, and the input data can be filled in the portion of each tag for inputting, and further the preparation, updating, and control of the format list can be facilitated.

An input apparatus for image in accordance with a seventh aspect of the present invention is adapted in the present invention in accordance with any one among the first to sixth aspects such that the foregoing processing means analyzes the contents of the description of the foregoing tag for inputting in the foregoing incorporated format list, and selects an input function corresponding to an analyzed result to change the operation into a corresponding input mode, and every time an input operation in the foregoing input mode is detected, analysis for the con tents of the description of the next tag for inputting in the foregoing format list is executed to successively change the operation to a corresponding input mode.

In accordance with the seventh aspect of the present invention the tag for inputting can be analyzed in order to achieve the operation of inputting for every input mode, so that the need of the operation of alteration of the input mode is eliminated to simply a series of the requests of inputting.

An input apparatus for image in accordance with an eighth aspect of the present invention is adapted in the present invention with the seventh aspect such that the foregoing processing means automatically executes, on the basis of set contents where any of the automatic execution of the foregoing transition of the foregoing input mode or the manual execution of the same is previously set, an analysis of the described contents of the tag for inputting in the foregoing format list and transition to a corresponding input mode upon setting of the automatic execution, while ensuring the manual execution of the transition of an input mode indicated by the next tag for inputting based upon operation selection by said operation means upon the setting of the manual execution.

In accordance with the eighth aspect of the present invention, upon the preparation of the format list, the alteration of the input mode can be arbitrarily altered manually with the aid of the arrangement where the input mode is automatically altered and of the operation of an operator, and upon the automatic setting of the operation of inputting is ensured, and further upon the manual setting the input mode is switched with the operation of an operator to easily grasp the present input mode.

An input apparatus for image in accordance with a ninth aspect of the present invention is adapted in the present invention in accordance with the eighth aspect such that the foregoing processing means, when the transition of the foregoing input mode is set to the manual execution, can arbitrarily select the execution of the analysis for the contents of the description of the next tag for inputting or the previous tag for inputting on the foregoing format list based upon an operation input by the foregoing operation means.

In accordance with the ninth aspect of the present invention, upon the manual setting for the input mode the operation can return to the previous tag for inputting to again execute the same input operation, so that an input operation is again ensured upon occurrence of an erroneous operation and so on to improve the convenience of the operation for inputting.

An input apparatus for image in accordance with a tenth aspect of the present invention is adapted such that it comprises: recording means for recording and storing at plurality of different input data recorded in the input apparatus for image; processing means having a function of incorporating a format list on which procedures of an input operation selectively employing a plurality of different input functions possessed by said input apparatus for image are described, and analyzing the contents of the description of a tag for inputting on the foregoing incorporated format list and automatically regenerating the input data recorded in said recording means corresponding to a result of the analysis in the order of the contents of the description of the tag for inputting in said format list; and display means for displaying said selected input data.

In accordance with the tenth aspect of the present invention, upon the selection of the regeneration mode the input data can be automatically regenerated in the order of the description of the format list, so that it is easily checked that the input data is prevented from being partly lost and leaking.

An input apparatus for image in accordance with an eleventh aspect of the present invention is adapted in the present invention in accordance with the tenth aspect such that the foregoing processing means is adapted such that the foregoing regeneration mode can be set to manual execution, and upon setting of the foregoing manual execution a regeneration processing for input data indicated by the contents of the description of the next tag for inputting or the previous tag for inputting on the foregoing format list based upon the selection of the operation of the operation means.

In accordance with the eleventh aspect of the present invention, the direction of the regeneration can be arbitrarily switched, so that it is more simply checked that the input data is lost and leaks.

An input apparatus for image in accordance with a twelfth aspect of the present invention is adapted in the present invention in accordance with the any one among the first to ninth aspects such that the foregoing processing means, when the operation changes to a corresponding input mode as a result of the analysis for the contents of the foregoing incorporated format list, guides and indicates the contents of the necessary operation for inputting to the foregoing display means with a character and the like.

In accordance with the twelfth aspect of the present invention, each input mode automatically changed is displayed, so that the present input mode can be grasped to ensure proper input operation.

An input apparatus for image in accordance with a thirteenth aspect of the present invention is adapted in the present invention in accordance with the twelfth aspect such that the foregoing processing means counts, upon analysis and execution for the contents of the foregoing incorporated format list, the total number of the tags for inputting described in the foregoing format list and the number of the tags for every the foregoing input mode, and displays list input information of the total number of input items, the number of input items for every input mode, and the list of the items and the like on the foregoing display means.

In accordance with the thirteenth aspect of the present invention, in a stage before the input operation, the outline of input operations required from now on can be grasped by the number of the operations.

An input apparatus for image in accordance with a fourteenth aspect of the present invention is adapted in the present invention in accordance with any one among the twelfth and thirteenth aspects such that the foregoing processing means displays, upon an analysis for the contents of the foregoing incorporated format list, an image obtained by developing the foregoing format list as an image on the foregoing display means, and displays as an image the contents of an input operation in a required input mode for every the foregoing tag for inputting described on the format list developed as the image.

In accordance with fourteenth aspect of the present invention, in a stage prior to the input operation, the outline of input operations required from now on and transition to a series of the respective input modes can be easily grasped.

An input apparatus for image according to a fifteenth aspect of the present invention is adapted in the present invention in accordance with any one among the first to fourteenth aspects such that on the foregoing format list an exclusive tag is described, in which tag the conditions of inputting such as conditions of photographing in each input mode can be set, and the foregoing processing means automatically sets the conditions of inputting indicated by the foregoing exclusive tag on the basis of the detection of the exclusive tag upon an analysis for the contents on the foregoing incorporated format list.

In accordance with the fifteenth aspect of the present invention, the conditions of inputting such as conditions of photographing in each input mode are automatically set with an analysis of the format list, so that input data with predetermined accuracy can be obtained without any specific operation properly and simply.

An input apparatus for image in accordance with a sixteenth aspect of the present invention is adapted in the present invention in accordance with the fifteenth aspect such that the foregoing processing means displays the contents of the foregoing conditions of inputting automatically set on the foregoing display means.

In accordance with the sixteenth aspect of the present invention, the conditions of photographing automatically set and the like are displayed, which conditions can be easily grasped.

An input apparatus for image in accordance with a seventeenth aspect of the present invention is adapted in the present invention in accordance with any one among the fifteenth and sixteenth aspects such that in or to the apparatus characteristics such as an input function possessed by the apparatus and attributes of a user can be registered or set, and the foregoing processing means is, when the foregoing exclusive tag is detected upon the analysis of the contents of the foregoing incorporated format list, validly/invalidly switchable for part or the whole of the automatic setting and the like and for the attributes of a user and for the need or non-need of the input operation indicated by the exclusive tag in response to the characteristics of the foregoing apparatus such as a function of inputting and the attributes of a user.

In accordance with the seventeenth aspect of the present invention, the presence of the input operation and the conditions of inputting can be automatically set in response to the function of inputting of the apparatus and the attributes of a user, and even when a single format is adapted to be incorporated with another apparatus, input data suitable for each apparatus and for each operator can be required to share the format list and facilitate the preparation.

An input apparatus for image according to an eighteenth aspect of the present invention is adapted in the present invention in accordance with any one among the first to seventeenth aspects such that on the foregoing format list an exclusive tag is described, which tag can set a transmission destination of the input data subject to the operation of inputting, the apparatus includes a communication processing section for transmitting the foregoing data of inputting subject to the operation of inputting to the outside, and the foregoing processing means automatically sets, when the exclusive tag of the foregoing transmission destination is detected upon the analysis for the contents of the foregoing incorporated format list, the conditions of transmission for transmitting the foregoing data of inputting to the foregoing transmission destination.

In accordance with the eighteenth aspect of the present invention, a format list updated by obtaining the input data on the basis of the incorporated format list can be transmitted to a specified transmission destination, so that necessary input data operated and inputted through each apparatus can be transmitted back to an external apparatus using the format list, and desired input data can be obtained in a concentrated manner to improve the efficiency and activation of data collection.

An input apparatus for image in accordance with a nineteenth aspect of the present invention is adapted in the present invention in accordance with the eighteenth aspect such that the foregoing processing means sets, when the foregoing destination of transmission is a mail address, the conditions of transmission for transmitting an electronic mail to the foregoing mail address and attaching the foregoing data of inputting to the foregoing electronic mail.

In accordance with the nineteenth aspect of the present invention, input data can be simply transmitted to a transmission destination using an electronic mail.

An input apparatus for image in accordance with a twentieth aspect of the present invention is adapted in the present invention in accordance with the eighteenth aspect such that the foregoing processing means automatically sets, when the foregoing destination of transmission is direct transmission to an external apparatus such as a personal computer, the computer name of the foregoing external apparatus and a transmission destination folder of the foregoing computer as the foregoing conditions of transmission.

In accordance with the twentieth aspect of the present invention, input data can be directly transmitted simply to an external apparatus.

An input apparatus for image in accordance with a twenty first aspect of the present invention is adapted in the present invention in accordance with the eighteenth aspect such that the foregoing processing means automatically sets, when the foregoing destination of transmission is transmission for a file to an FTP server, the name of the foregoing FTP server and a transmission destination folder of the foregoing FTOP server as the foregoing conditions of transmission.

In accordance with the twenty first aspect of the present invention, input data can be simply transmitted to the FTP server.

### BRIEF DESCRIPTION OF THE DRAWINGS

FIG. 1 is a block diagram illustrating the whole arrangement of a digital camera apparatus that is an input apparatus for image associated with a preferred embodiment of the present invention;

FIG. 2 is a view illustrating an example of the contents of the description of a format list incorporated in an input apparatus for image associated with a first preferred embodiment of the present invention;

FIG. 3 is a flow chart illustrating the procedures of the processing for inputting based upon the format list of the input apparatus for image associated with the first preferred embodiment of the present invention;

FIG. 4 is a screen for guidance displayed upon photographing for a still image in the input apparatus for image associated with the first preferred embodiment of the present invention;

FIG. 5 is a screen for guidance displayed upon recording of a voice in the input apparatus for image associated with the first preferred embodiment of the present invention;

FIG. 6 is a screen for guidance displayed upon photographing for an animation in the input apparatus associated with the first preferred embodiment of the present invention;

FIG. 7 is a screen for guidance displayed upon inputting of a character in the input apparatus for image associated with the first preferred embodiment of the present invention;

FIG. 8 is a screen for a character used upon inputting the character in the input apparatus for image associated with the first preferred embodiment of the present invention;

FIG. 9 is a view illustrating an exemplary completed format list in the input apparatus associated with the first preferred embodiment of the present invention;

FIG. 10 is a screen for display where the format list is developed as an image in the input apparatus for image associated with the first preferred embodiment of the present invention;

FIG. 11 is a view illustrating an example of the contents of the description of a format list in an input apparatus for image associated with a second preferred embodiment of the present invention;

FIG. 12 is a flow chart illustrating the procedures of a processing for inputting based upon the format list in the input apparatus for image associated with the second preferred embodiment of the present invention;

FIG. 13 is a view illustrating an example of a completed format list in the input apparatus for image associated with the second preferred embodiment of the present invention;

FIG. 14 is a screen for display where the format list is developed as an image, in the input apparatus for image associated with the second preferred embodiment of the present invention;

FIG. 15 is a view illustrating the contents of the description of a format list in an input apparatus for image associated with a third preferred embodiment of the present invention;

FIG. 16 is a flow chart illustrating the procedures of a processing for inputting based upon the format list in the input apparatus associated with the third embodiment of the present invention;

FIG. 17 is a view illustrating an example of a completed format list in the input apparatus for image associated with the third preferred embodiment of the present invention;

FIG. 18 is a view for displaying illustrating the format list developed as an image in the input apparatus for image associated with the third preferred embodiment of the present invention;

FIG. 19 is a flow cart illustrating the procedures of the processing for inputting based upon a format list in an input apparatus for image associated with a fourth embodiment of the present invention;

FIG. 20 is a flow chart illustrating the procedures of a processing for automatic regeneration based upon a format list in an input apparatus for image associated with a fifth preferred embodiment of the present invention; and

FIG. 21 is a view illustrating a screen for guidance for an operation for inputting in an input apparatus for image associated with a sixth preferred embodiment of the present invention;

FIG. 22 is a flow chart illustrating the procedures of a processing for inputting based upon a format list in an input apparatus for image associated with a seventh preferred embodiment of the present invention; and

FIG. 23 is a view illustrating an exemplary display for input information for the list with an analysis for the format list in the input apparatus for image associated with the seventh preferred embodiment of the present invention.

FIG. 24 is a view illustrating an example where a format list is developed as an image in the input apparatus for image associated with an eighth preferred embodiment of the present invention;

FIG. 25 is a view illustrating an example of the contents of the description of a format list in an input apparatus for image associated with a ninth preferred embodiment of the present invention;

FIG. 26 is a flow chart illustrating the procedures of a processing for inputting based upon the format list in the input apparatus for image associated with the ninth preferred embodiment of the present invention;

FIG. 27 is a view illustrating an example of a display for the contents of setting for the conditions for inputting based upon the format list in the input apparatus for image associated with the ninth preferred embodiment of the present invention;

FIG. 28 is a flow chart illustrating the procedures of a processing for inputting based upon a format list in an input apparatus for image associated with a tenth preferred embodiment of the present invention;

FIG. 29 is a view illustrating an example of the contents of the description of a format list in an input apparatus for image associated with an eleventh preferred embodiment of the present invention;

FIG. 30 is a flow chart illustrating the procedures of the processing of automatic setting for the conditions of transmission based upon the format list in the input apparatus for image associated with the eleventh preferred embodiment of the present invention;

FIG. 31 is a view illustrating an example of a display upon transmission of an electronic mail by an analysis for the format list in the input apparatus for image associated with the eleventh preferred embodiment of the present invention;

FIG. 32 is a view illustrating a screen for display upon preparation of the electronic mail in the input apparatus for image associated with the eleventh preferred embodiment of the present invention;

FIG. 33 is a view illustrating an example for display upon direct transmission by an analysis for the format list in the input apparatus for image associated with the eleventh preferred embodiment of the present invention;

FIG. 34 is a view illustrating a screen for display upon the direct transmission in the input apparatus for image associated with the eleventh preferred embodiment of the present invention;

FIG. 35 is a view illustrating a screen for display upon the direct transmission in the input apparatus for image associated with the eleventh preferred embodiment of the present invention;

FIG. 36 is a view illustrating an example of display upon the uploading of FTP by an analysis for the format list in the input apparatus fir image associated with the eleventh preferred embodiment of the present invention; and

FIG. 37 is a view illustrating a screen for display upon the uploading of FTP in the input apparatus for image associated with the eleventh preferred embodiment of the present invention.

### DETAILED DESCRIPTION OF THE PREFERRED EMBODIMENTS

In what follows, there will be described in detail preferred embodiments of an input apparatus for image according to the present invention with reference to the accompanying drawings. In the respective preferred embodiments described below there will be taken a portable digital camera apparatus in an exemplary fashion as the input apparatus for image.

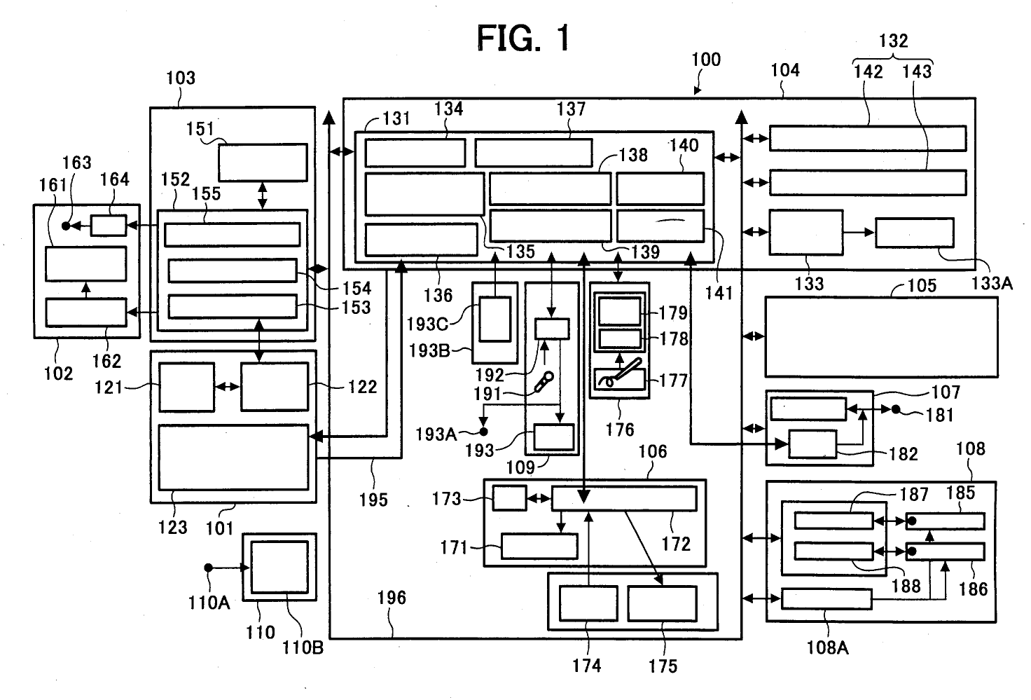

Referring to FIG. 1, there is illustrated the entire arrangement of a digital camera apparatus in the form of a block diagram.

As illustrated in the same figure, a digital camera apparatus 100 comprises a camera section 101, a display section 102, an image data recording section 103, a main control section 104, a recording section 105, an operation section 106, an I/F section 107, a card slot section 108, a voice data recording section 109, and a power supply section 110, etc.

The camera section 101 comprises a CCD 121 for photographing an article to be photographed, a CCD driver 122, and a driving section 123 for an AF, a shutter, and a stroboscope, etc.

The main control section 104 substantially comprises a processing section (CPU) 131, a memory 132, and a port 133. The processing section 131 has functions for supervising the operation of the entire apparatus and executing editing of image data. The processing section 131 comprises a camera processing section 134, image editing/synthesis processing section 135, a communication processing section 136, a voice/animation processing section 137, a photographing list processing section 138, a command processing section 139, a ciphering/watermark processing section 140, and a character mode processing section 141, etc.

The camera processing section 134 executes setting and correction for AE(exposure), CCDAF(focus), AWB(white balance), and the like. The picture editing/synthesis processing section 135 executes editing for photographed image data (a retouch, a superscribed character, etc.). The communication processing section 136 executes a processing of converting image data to a format where the data can be attached to an electronic mail and the like, and transmitting it to the outside. The voice/animation processing section 137 controls recording and regeneration of a voice or an animation in the apparatus, and compresses these recorded data.

The photographed list processing section 138 controls a photographed list of photographed image data and folders of the same. The photographed list processing section 138 further instructs procedures of operations of the apparatus (photographing, inputting of a text, etc.) in the order of description in a format list described later. The command processing section 139 analyzes and executes commands delivered upon controlling of the operations of the respective sections of the apparatus, and controls executed operations. The command processing section 139 further controls the respective sections based upon the instruction of the procedures of the photographed list processing section 138 upon inputting of the format list.

The ciphering/water mark processing section 140 executes a processing of ciphering or water mark for image data outputted upon desiring upon an external output of photographed image data. The character mode processing section 141 executes a binary processing optimized such that when an object upon photographing is a character and the like, it can record the character clearly.

The memory 132 comprises an internal memory 142 and a ROM 143. The internal memory 142 is formed with an SDRAM and serves for temporal storage upon photographing and upon image processing. The ROM 143 is formed with a flash ROM, in which there are stored a system control program for the whole of the apparatus, fonts for character display in the display section, icons, etc.

The image data recording/regeneration section 103 controls recording (videotaping) and regeneration for image data for the main control section 104 and outputs the image to the display section 104 for monitoring, which image data recording/regeneration section comprises the frame memory 151 such as an SDRAM, and the image control IC 152. A CCD control section 153 of the image control IC 152 outputs control data for the CCD driver 122. An image processing section 154 converts photographed image data to an image. An image compression/expansion section 155 compresses and expands image data in a general purpose JPEG form.

The display section 102 includes a liquid crystal display section (TFTLCD) 161 for displaying a image, an LCD control section 162, an external output terminal 163, and an amplifier 164, etc.

The recording section 105 comprises a flash memory, which stores various data such as photographed image data (the original picture), mail data, voice data, handwritten data, network service, and a format list prepared by a PC described later, etc.).

The operation section 106 includes an operation button 171 for operating recording/regeneration (photographing, regeneration and the like) of the apparatus, a CPU 172 for detecting the operation state of the operation button 171, and a timer (RTC) 173 for driving the CPU 172. The operation button 171 includes a mode dial where various settings are facilitated for each mode. The operation section 106 includes a remote controller 174 for remote operation for the apparatus, on which remote controller an LCD 175 is provided for simply displaying operation contents.

The present apparatus further includes a touch panel 176, on which operations such as setting and so on are available with a finger and a pen. The touch panel 176 includes an input pad 177, an A/D 178, and a coordinate conversion section 179 for detecting a contact position (X_Y coordinates) on the input pad.

The I/F section 107 incorporates the format list from a personal computer PC (not shown), and serves as an interface for transmitting the format list after completed, on which there are provided a general purpose RS232C, an I/F terminal 181 such as a USB, and a driver IC 182, etc.

The card slot section 108 serves as an interface for recording image data and the like in various external recording media (e.g., a compact flash, and a PC card, etc.) which can be inserted into the card slot section 108 and pulled out therefrom, which includes card slots 185, 186 for each configuration, and corresponding I/F control sections 187, 188. Various data such as image data and the like recorded in the recording section 105 can be recorded in an external storage medium mounted on the card slot section 108.

The voice data recording/regeneration section 109 comprises a microphone 191 for recording, an amplifier section 192, a speaker 193 for recording/regeneration, etc. The power supply section 110 supplies a driving electric source for the aforementioned respective components

In the digital camera apparatus constructed as described above a image data photographed by the camera section 101 is outputted to the main control section 104 through a data line 195. The main control section 104 and the other respective components are connected with each other through an internal bus 196 for mutual delivery of data required for recording and regeneration thereamong.

In the following, there will be described a multi-media inputting function employing the format list that is a characteristic function of the present invention. In the present invention, additionally to the capturing function for image information that is the fundamental function of the digital camera apparatus 100 a function previously incorporating a format list prepared previously by a personal computer (PC) is added.

Based upon the incorporated format list input information such as image/voice/animation/character (text) is inputted by indicating it to a user or automatically inputted to prepare a format for multimedia inputting in conformity with a request.

Information of images, etc., recorded in response to the format list is incorporated into a PC and the like and utilized, and once the format is prepared in an HTML format for example, it can be effectively utilized such that the format is directly carried on the Web on the Internet.

In the following, various modes concerning the multimedia input function will be described. In a PC (not shown) external to the digital camera apparatus 100, a format list is prepared for executing a function for inputting multimedia input information, i.e., input information such as image/voice/animation/character by indicating those pieces of information to a user or automatically inputting them into the digital camera apparatus 100.

First Preferred Embodiment

A format list prepared in an external apparatus such as a personal computer (PC) is inputted into a main control section 104 through an I/F section 107, and is recorded in a recording section 105. A processing section 131 of the main control section 104 analyzes the format list, and executes a processing for multimedia inputting. To be concrete, the operation is automatically moved to an input mode on the basis of an analysis for the format list to urge a user to input information. Thereupon, an analyzed result is outputted and displayed on a display section 102. The user operates an operation section 106 based upon display contents on the display section 102.

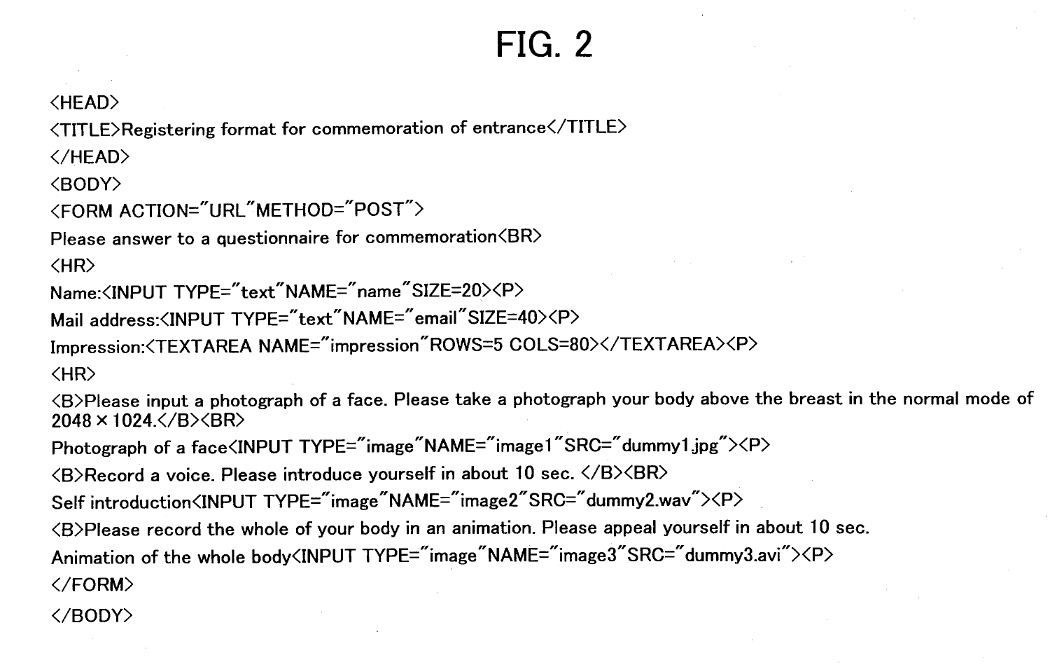

Referring to FIG. 2, description contents on the format list is exemplarily illustrated. In preferred embodiments described below, use is made of a description language in the HTML format as an example for the format list. A processing section 131 analyzes the type of an input tag on the format list to judge whether it is a text input or an image input. For example, in a line for inputting an image illustrated in the figure, the kind of the image is recognized on the basis of an extension factor of a “dummy” file in the definition of SRC to set the operation to an input mode corresponding the kind of the image, whereby photographing in the camera section 101 is executed, and image data is incorporated into a PC.

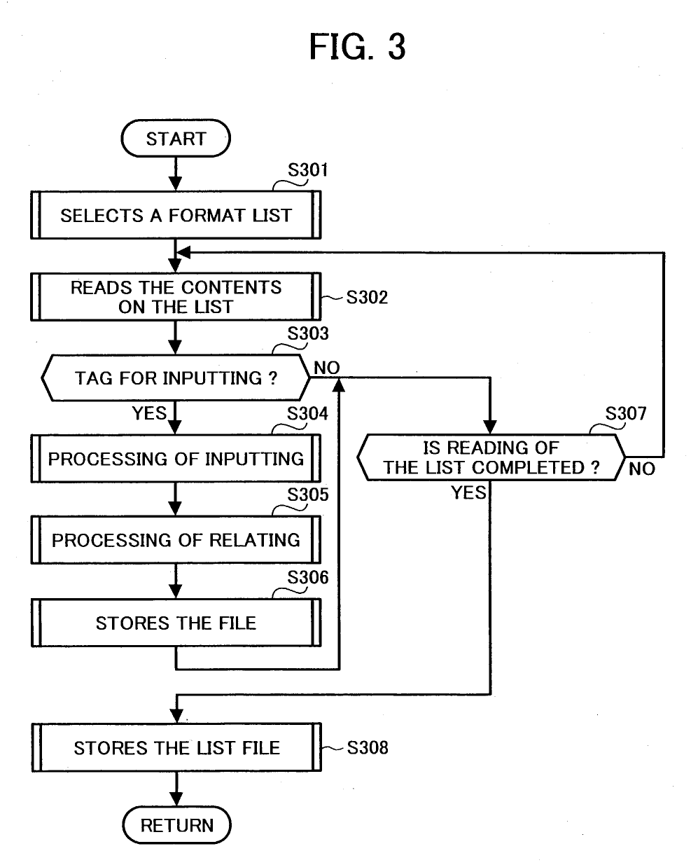

Referring to FIG. 3, a flow chart illustrating procedures of an input processing based upon the format list is provided. Details of the input processing will be described in conformity with the flow chart. The processing section 131 first displays an operation guide screen on a liquid crystal display section 161 in the display section 102. An operator selects the format list while observing the display screen in step S301.

Then, the processing section 131 reads the selected format list in step S302, and detects whether or not an inputting tag is existent in step S303. When the inputting tag is finished (No in step S303), the operation moves in turn to step S307.

When the inputting tag is detected (Yes in step S303), a corresponding input processing is executed in step S304. The input processing in this case includes any among still image photographing, voice recording, animation photographing, and text inputting, etc., which are selected in succession in the order of the description of the format list.

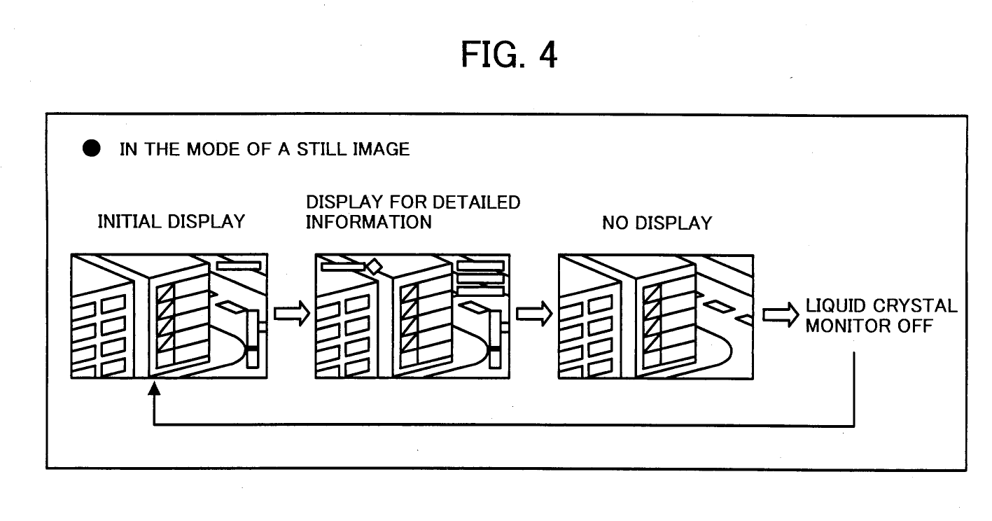

Referring now to FIGS. 4 to 8, there are illustrated display screens in respective input modes. Each guide screen for photographing of a still image, recording of a voice, photographing of an animation, and inputting of a character is displayed in response to the contents of the tag for inputting on the format list. FIG. 4 illustrates a guide screen upon photographing a still image, on which display or non-display for a photographed image can be selectively changed over together with the changeover of display or non-display for detailed information of the operation guide.

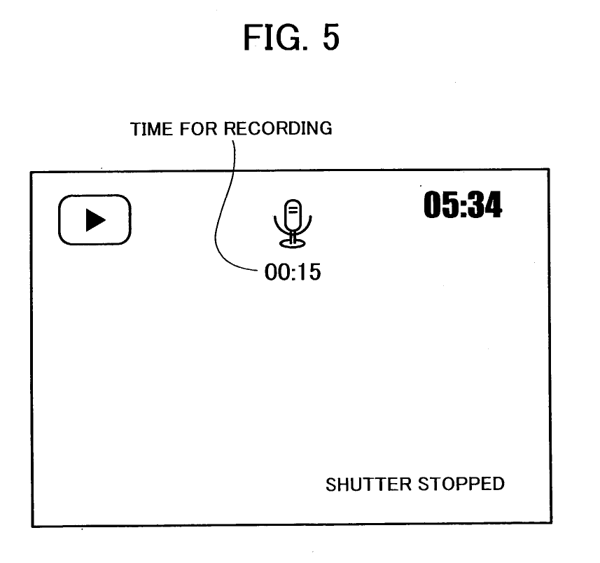

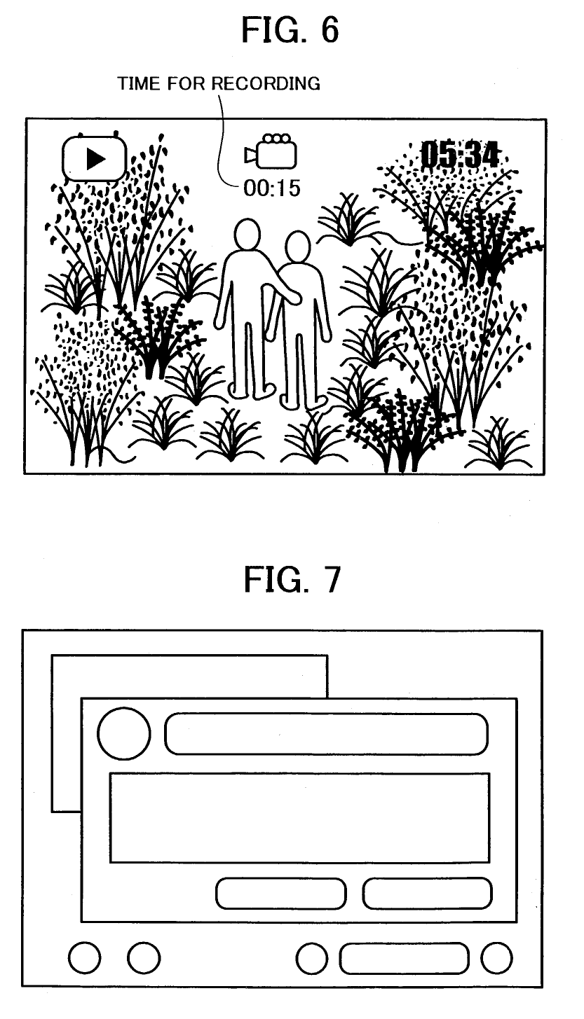

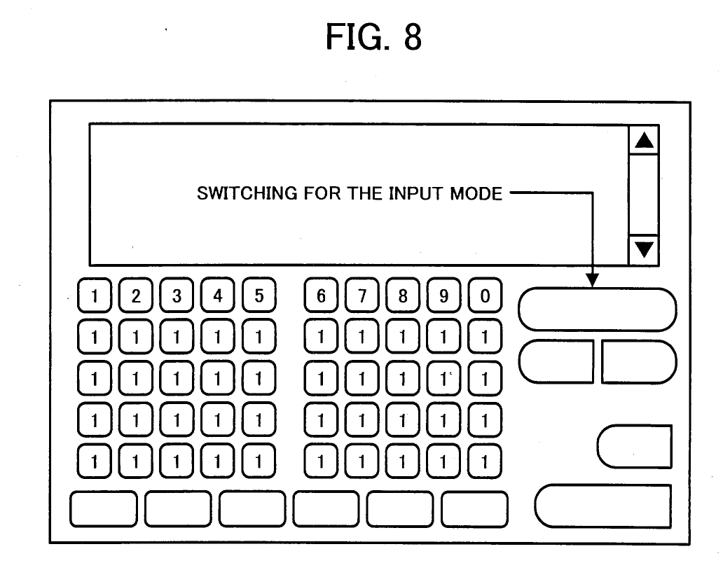

FIG. 5 illustrates a guide screen upon recording a voice, on which time for recording and the like are displayed. FIG. 6 illustrates a guide screen upon photographing an animation, on which a time for recording and the like are displayed. FIG. 7 illustrates a guide screen upon inputting a character, on which a list of character keys illustrated in FIG. 8 is displayed with the operation of keyboard keys displayed on the guide screen and is ready for inputting any character (in kana, and in English characters).

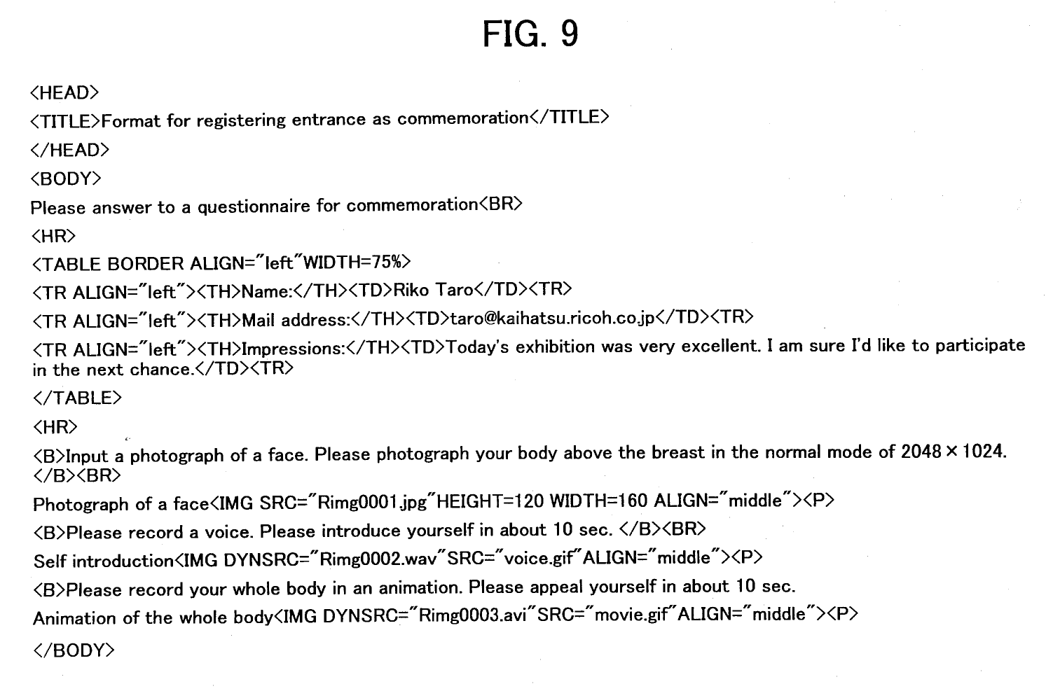

Then, respective files subject to the input processing in the order of reading of the list are related in conformity with identifiers to fill the list in step S305. An example of a completed format list after the respective files are filled by a user is illustrated in FIG. 9. In the present example, a result of an answer to a questionnaire, a name, a mail address, and an impression sentence are inputted in the form of a text, and further a photograph of a face, an animation of a whole body, and a voice (voice for self introduction) are inputted, respectively.

The files inputted as such are stored in the recording section 105 in order in step S306, and the operation returns to step S302 to repeatedly process the foregoing contents until the reading of the list is completed (No in step S307). Once the reading of the list is completed (Yes in step S307), a complete format list is stored in the recording section 105 in step S308, and the operation is ended (returned).

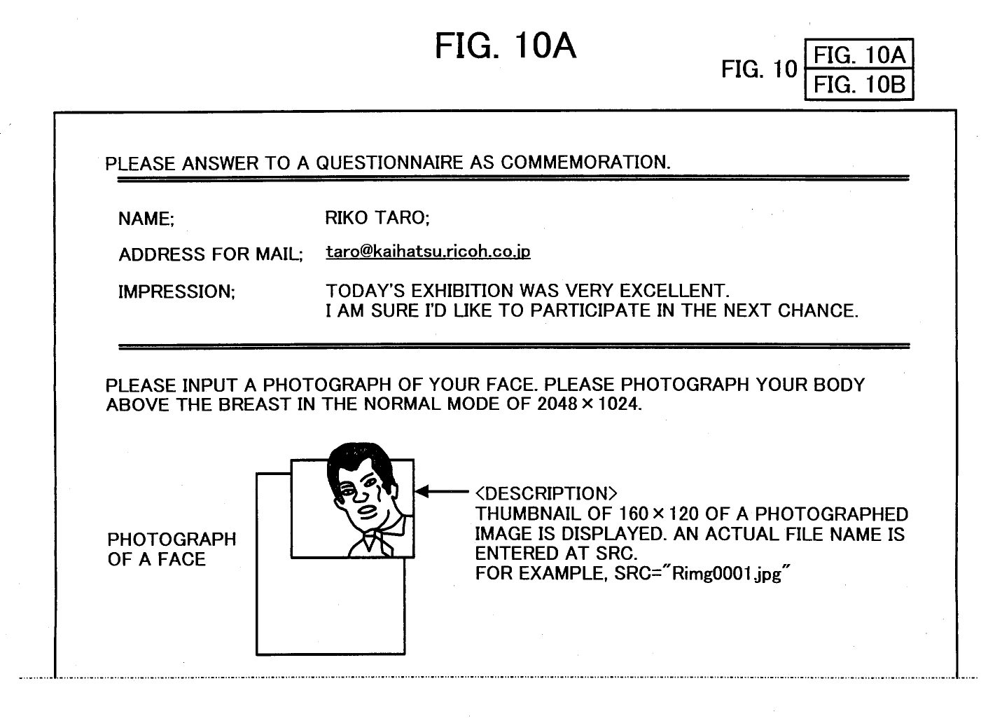

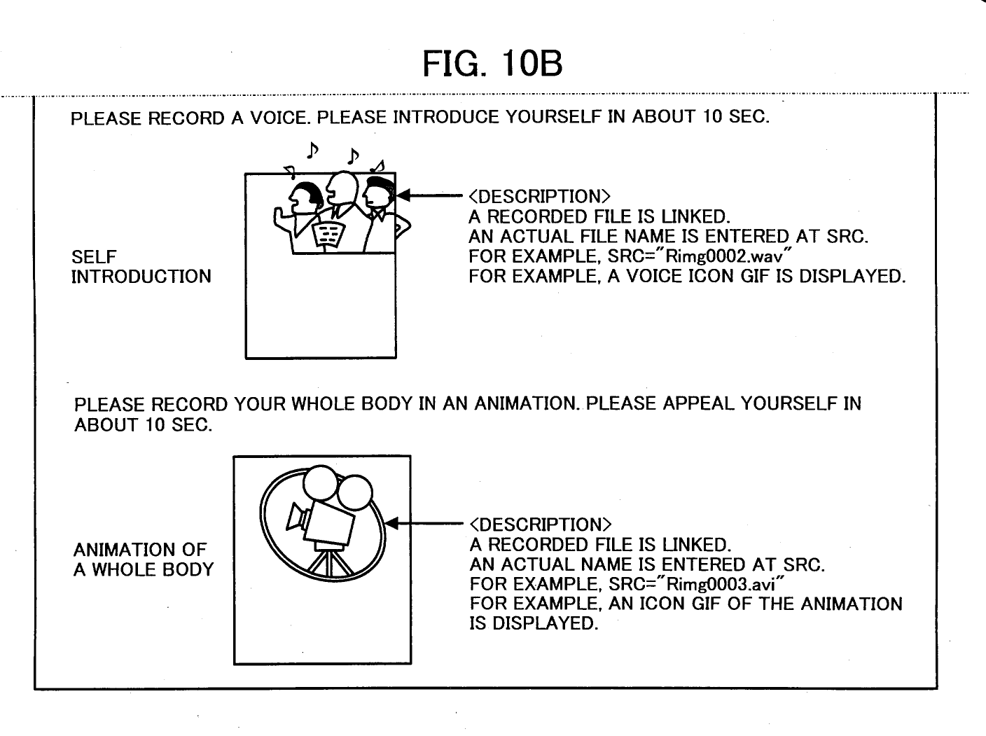

As described above, an input mode is judged by analyzing a tag on the format list inputted externally from a PC, whereby the apparatus automatically changes to a suitable input mode successively to smoothly pursue multimedia inputting following the procedures. Referring to FIG. 10, a screen is illustrated, in which a complete format list is developed on the display section 102 as an image.

As illustrated in the same figure, respective guide screens of input modes (name, mail address, a photograph of a face, a voice for self introduction, and an animation for a whole body) are displayed as images to urge a user to input necessary information. The user can automatically complete a requested format and simplify the operation only by inputting every time necessary photographing of a still image, photographing of an animation, and inputting of a text, etc., in conformity with an instruction.

Second Preferred Embodiment

In the following, there will be described a second preferred embodiment of the present invention. In the second preferred embodiment, the processing section 101 collects recorded conditions and the attribute of a file for every file, and records them on the recording section 105.

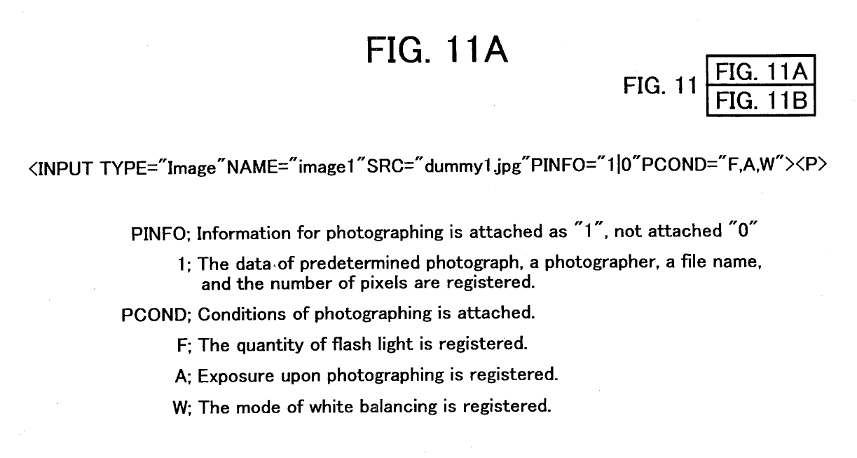

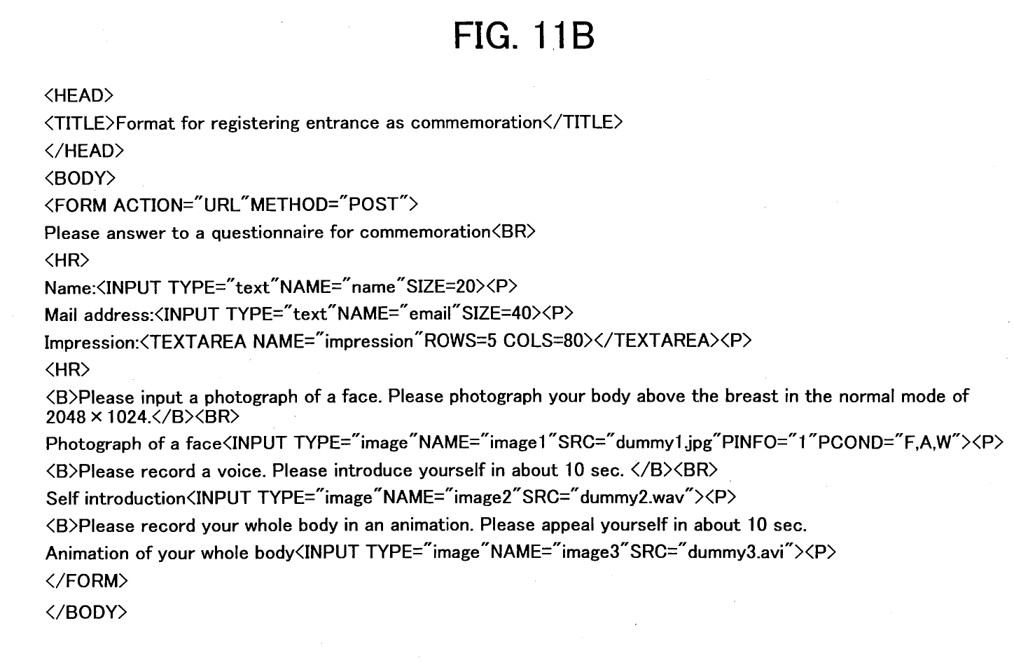

Referring to FIG. 11, a format list described in the form of HTML is exemplarily illustrated. As in the first embodiment, the processing section 131 judges whether the input mode is inputting of a text or inputting of an image by analyzing the type of a tag for inputting on the format list, and in a line of inputting of an image illustrated it recognizes the kind of the image following the extension factor of a “dummy” file in the definition of SRC, and changes the operation to an input mode corresponding to the kind of the image to force the camera section 101 to execute photographing of any image for incorporation of image data. Further, the processing section 131 records an input file, associating it with its position on the format list, and father records information such as recording conditions and the attribute of a file, associating the information with its file.

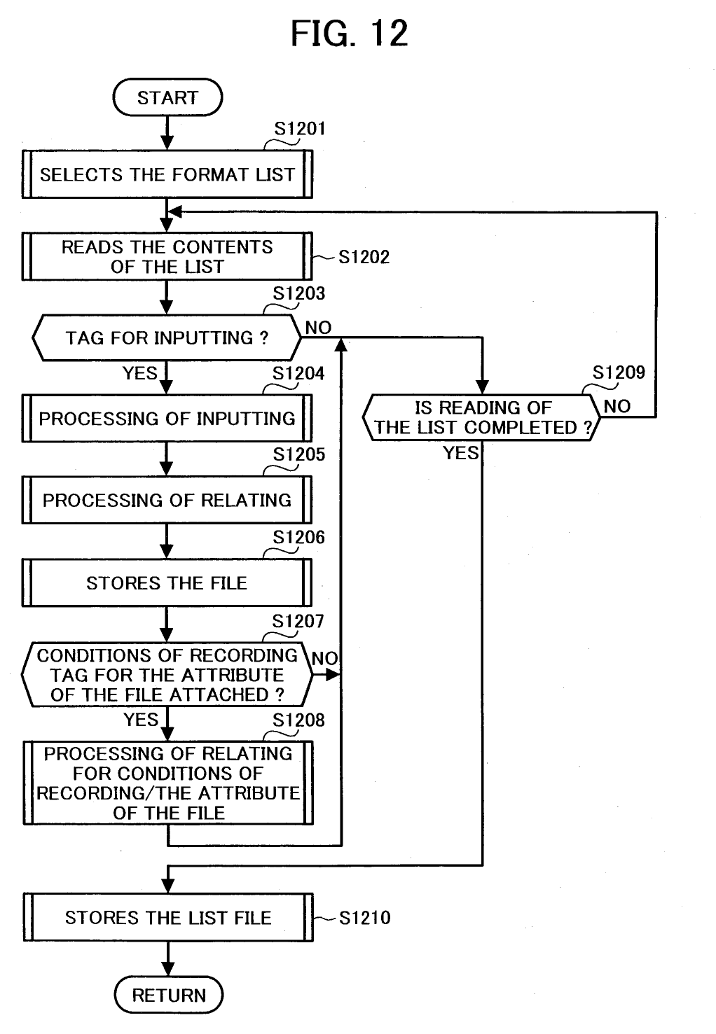

Referring to FIG. 12, a flowchart illustrating procedures of the input processing according to the second embodiment is provided. The processing section 131 displays the operation display screen on a liquid crystal displaying section 161 in the display section 102. An operator selects the format list while observing the display screen in step S1201. Then, the processing section 131 reads a selected format list in step S1202, and detects whether or not a tag for inputting is existent in step S1203. When the tag for inputting is finished (No in step S1203), the operation moves to step S1209.

When the tag for inputting is detected (Yes in step S1203), a corresponding processing for inputting is executed in step S1204. The processing for inputting herein includes any among photographing of a still image, recording of a voice, photographing of an animation, and inputting of a text, and so on, which are selected in order in the order of the description on the format list. Hereupon, as described above, the display screens for the respective input modes illustrated in FIGS. 4 to 8 are displayed for guidance, and an operator performs a corresponding input operation.

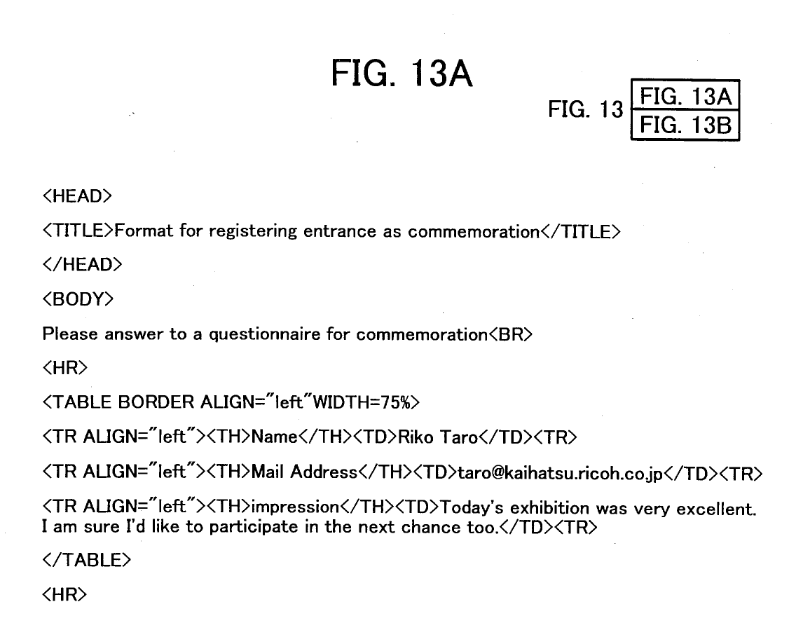

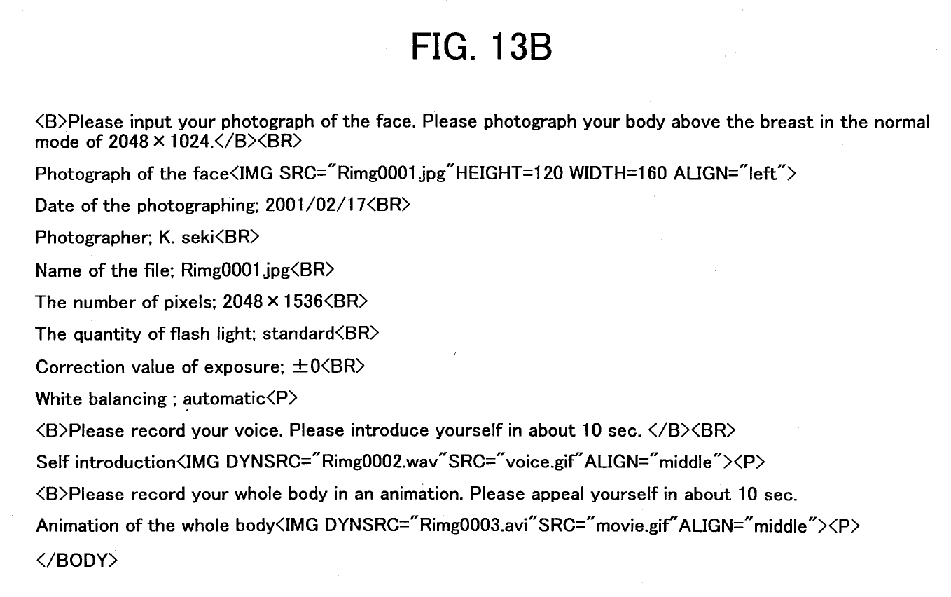

Then, files subject to the processing for inputting in the order of reading of the list are related to identifiers to fill the list in step S1205. FIG. 13 illustrates a complete example of the format list after each file is filled by an operator. In this example, a result of an answer to a questionnaire, a name, a mail address, and an impression sentence are inputted in the form of a text, and further a photograph of a face, an animation of a whole body, and a voice (a voice for self introduction) are inputted, respectively.

The input files are stored in order in the recording section 105 in step S1206. Simultaneously, the processing section 131 detects whether or not conditions of recording and attributes of the files are attached in step S1207. The conditions of recording include the time and date of recording of each input data, a photographer, a file name, the number of pixels, the amount of flash light, a correction value of exposure, and white balance, etc.

When the conditions of recording and the attributes of files are attached (Yes in step S1207, the conditions of recording and the attributes of files are related to the files and are stored in the recording section 105. When the attributes are not attached (No in step S1207), the operation moves to step S1209 for repeatedly processing the foregoing contents.

The operation returns to step S1202 for repeatedly processing the foregoing contents until the reading of the list is completed (No in step S1209). When the reading of the list is completed (Yes in step S1209), a complete format list is stored in the recording section in step S1210 into the end of the operation.

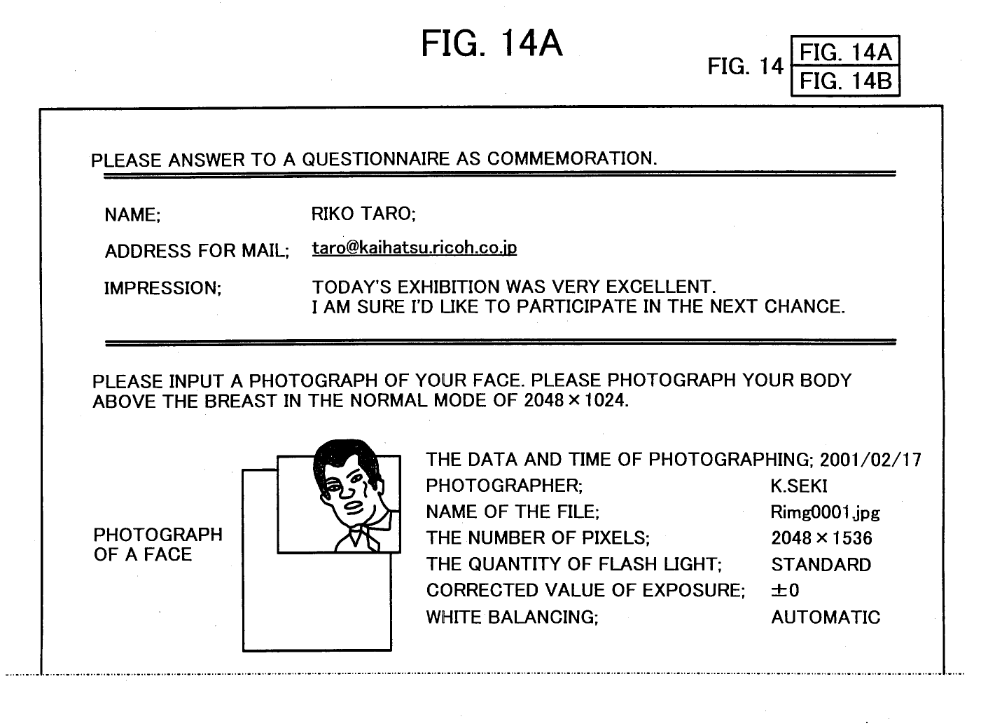

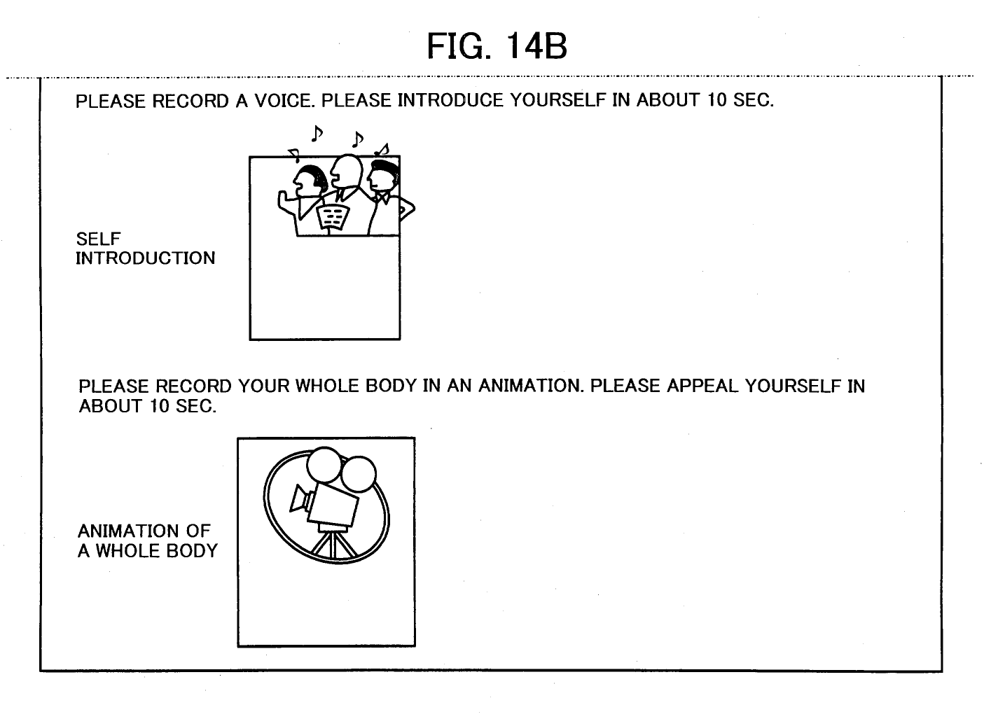

Referring to FIG. 14, a view is provided, illustrating a guide screen on which the complete format list is developed as an image and displayed on the display section 102. As illustrated in the figure, the respective guide screens in the input mode (a name, a mail address, impressions, a photograph of a face, a voice for self introduction, an animation of a whole body) are displayed successively on the display section 102 to urge a user to input necessary information. An operator can automatically complete a required format only by inputting every time photographing of a necessary still image, photographing of an animation, inputting of a text, etc., in response to an instruction, resulting in a simplified operation. Simultaneously, a list of the foregoing conditions of recording is displayed on the side of a still image in FIG. 14. for confirmation of the conditions of recording.

Third Preferred Embodiment

The third preferred embodiment is adapted such that the apparatus and the attribute of a user can he previously registered on the recording section 105 in the digital camera apparatus 100. When a result of the analysis of contents on the incorporated format list is related to the foregoing attributes previously registered in the apparatus, attributes of the apparatus and a user are related to a corresponding position of description on the format list.

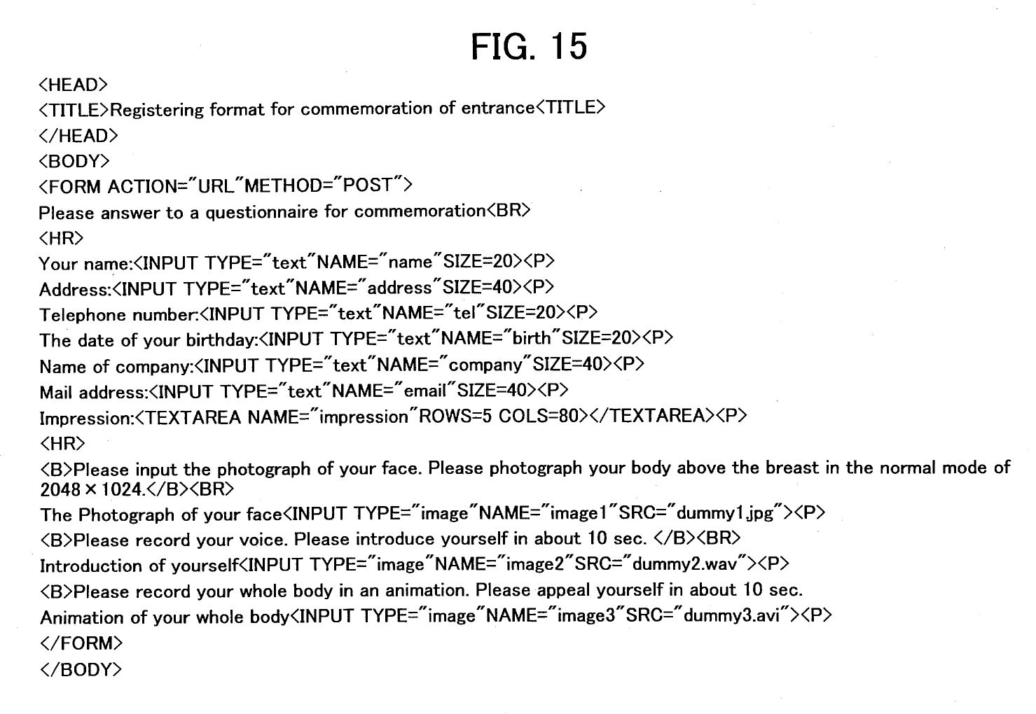

Referring to FIG. 15, there is illustrated an example of a format list described in the format of HTML. The processing section 131 analyzes the type of the tag for inputting on the format list, and automatically changes to a corresponding input mode. Further, when the attributes of the apparatus and a user are previously registered, the contents of the attributes are written at a corresponding position on the format list.

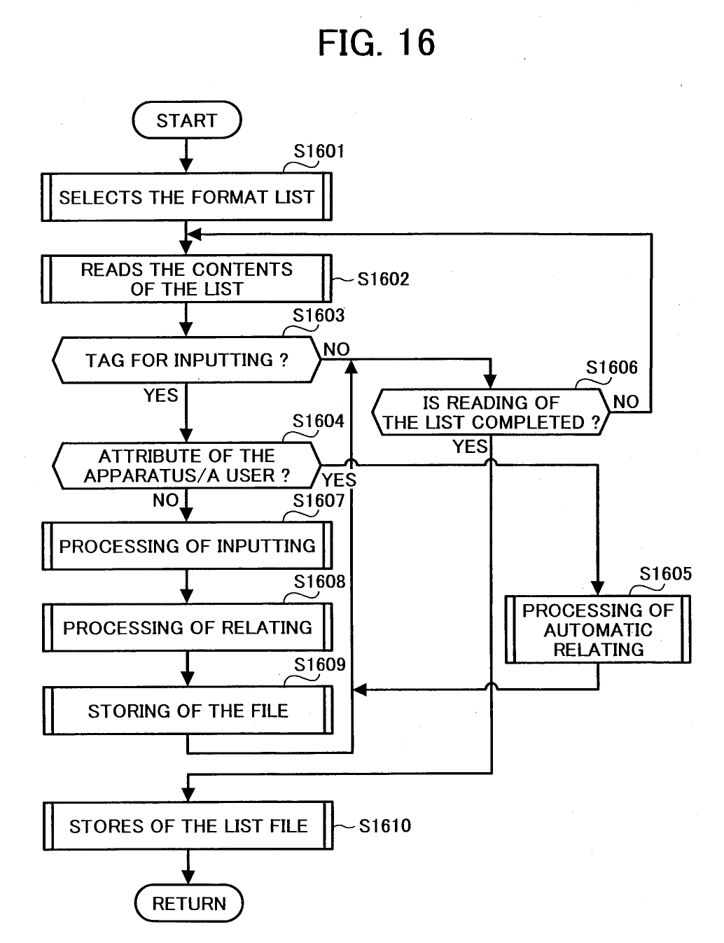

Referring to FIG. 16, a flow chart is provided, illustrating procedures of the processing of inputting according to the third embodiment. The processing section 131 displays a screen for guidance for the operation on a liquid crystal display section 161 in the display section 102. An operator selects a format list while observing the display screen in step S1601. Then, the processing section 131 reads a selected format list in step S1602, and detects whether or not a tag for inputting is existent ion step S1603. When the tag for inputting is finished (No in step 81603), the operation proceeds to step S1606.

When the tag for inputting is inputted (Yes in step S1603), it is checked whether or not the tag for inputting concerns the attributes of the apparatus and a user in step S1604. When the tag for inputting concerns the attributes of the apparatus and a user (Yes in step S1604), the attributes of the apparatus and a user previously registered are inputted at a corresponding position on the format list in step S1605, and the operation proceeds to step S1606. In contrast, When the attributes of the apparatus and a user are not inputted (No in step S1604), a processing for inputting corresponding to the contents of description of the tag for inputting is executed in step S1607.

The processing for inputting herein involves any among photographing for a still image, recording for a voice, and inputting for a text, etc., which are selected successively in the order of the description of the format list. Thereupon, as described above, display screens of the respective input nodes illustrated in FIGS. 4 to 8 are displayed for guidance, and an operator performs a corresponding processing for inputting.

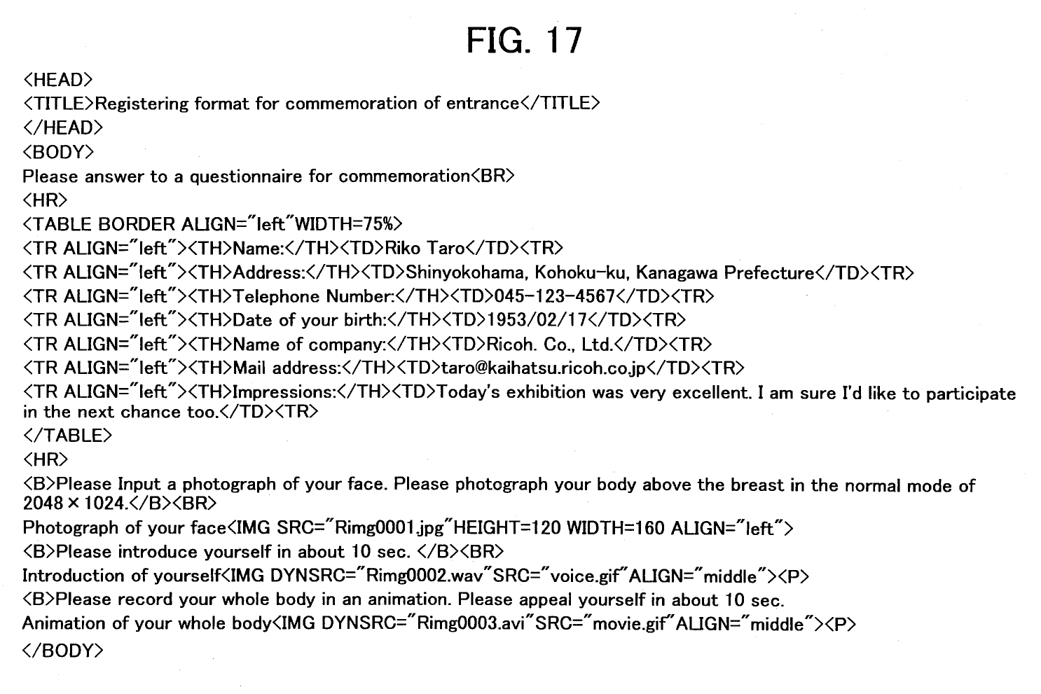

Then, the respective files subject to the processing for inputting are related by identifiers in the order of reading of the list to fill the list in step S1608. FIG. 17 illustrates an example of a completed format list after the foregoing attributes of the apparatus and a user are automatically inputted into the apparatus. In the present example, a result of an answer to a questionnaire, a name, a mail address, and an impressions sentence are inputted in the form of a text, and a photograph of a face, an animation of a whole body, a voice (a voice of self introduction) are automatically inputted, respectively.

The input files are stored in the recording section 105 in step S1609. Thereafter, the operation returns to step S1602 to repeatedly process the foregoing contents until the reading for the list is completed (No in step S1606). When the reading for the list is completed (Yes in step S1606), a complete format list is stored in the recording section 105 (Yes in step S1606), resulting in the end of the operation.

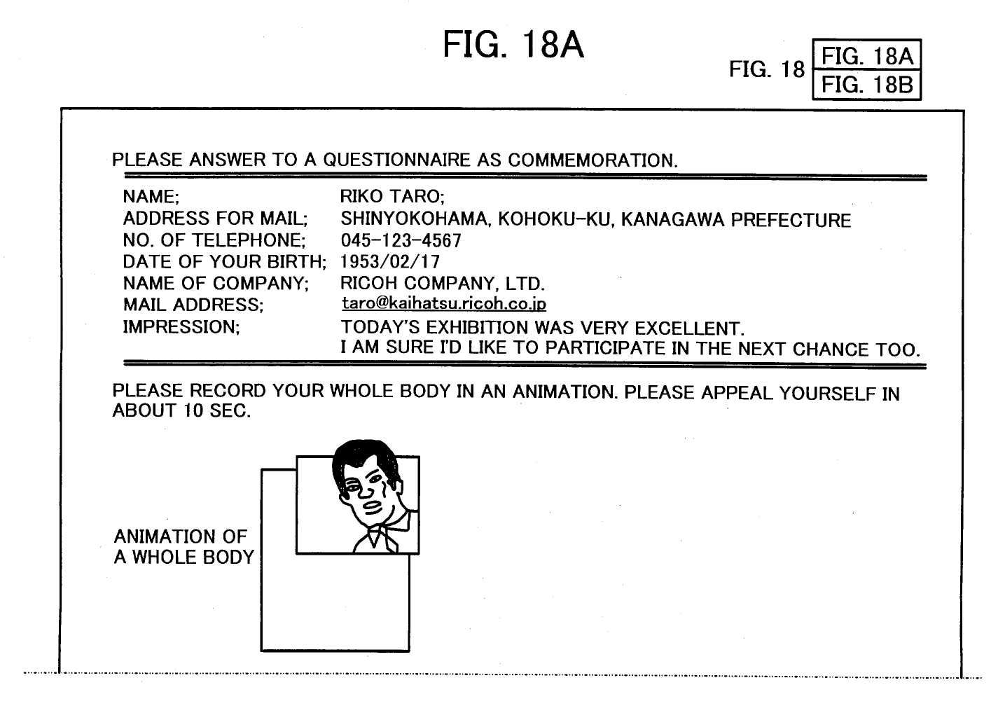

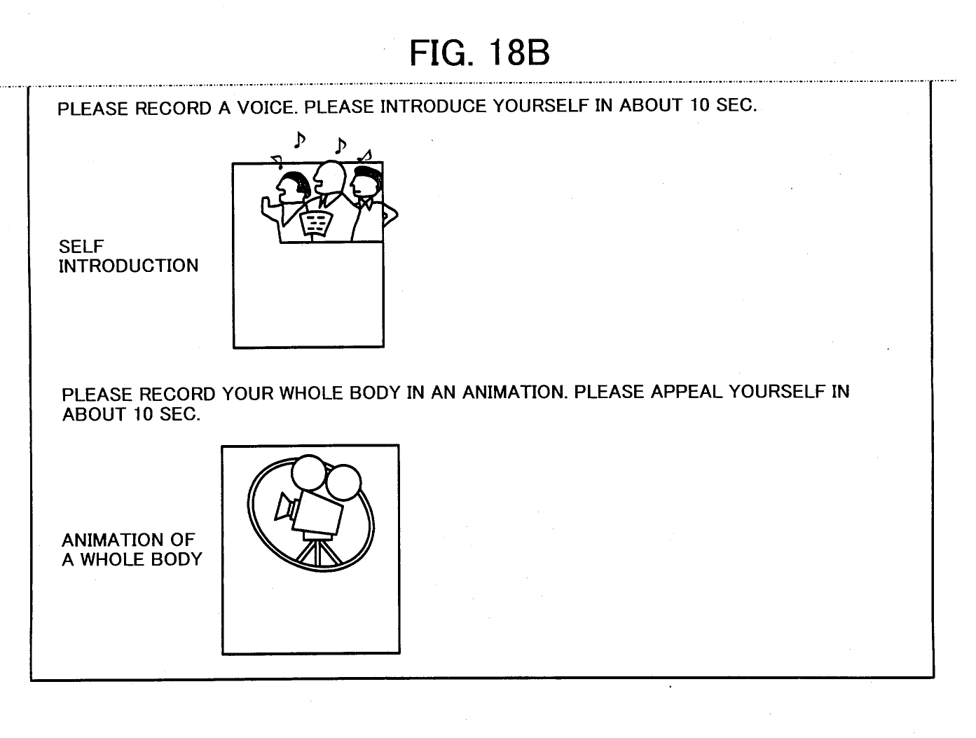

Referring to FIG. 18, a view is provided, in which the format list is developed as an image on the display section 102. As illustrated in the figure, respective guide screens in the input mode (a name, an address, a telephone number, the date of user's birth, the name of a company, a mail address, impressions, a photograph of a face, a voice of self introduction, and an animation of a whole body) are displayed on the display section 102, and a user is urged to input necessary information.

Herein, when the attributes of the apparatus and an operator are previously stored, necessary data such as a still image, an animation, and inputting of a text are inputted at a corresponding position on the format list to ensure the completion of the format list, resulting in a simplified operation. In the illustrated example, inputting of characters (a name, an address, a telephone number, the date of user's birth, a name of a company, a mail address, impressions) is automatically inputted for ease of the operation for inputting.

Fourth Preferred Embodiment

In what follows, a fourth preferred embodiment will be described. In the fourth embodiment, reading and inputting for the format list are adapted arbitrarily movably switchably, and automatically/manually by the choice of a user.

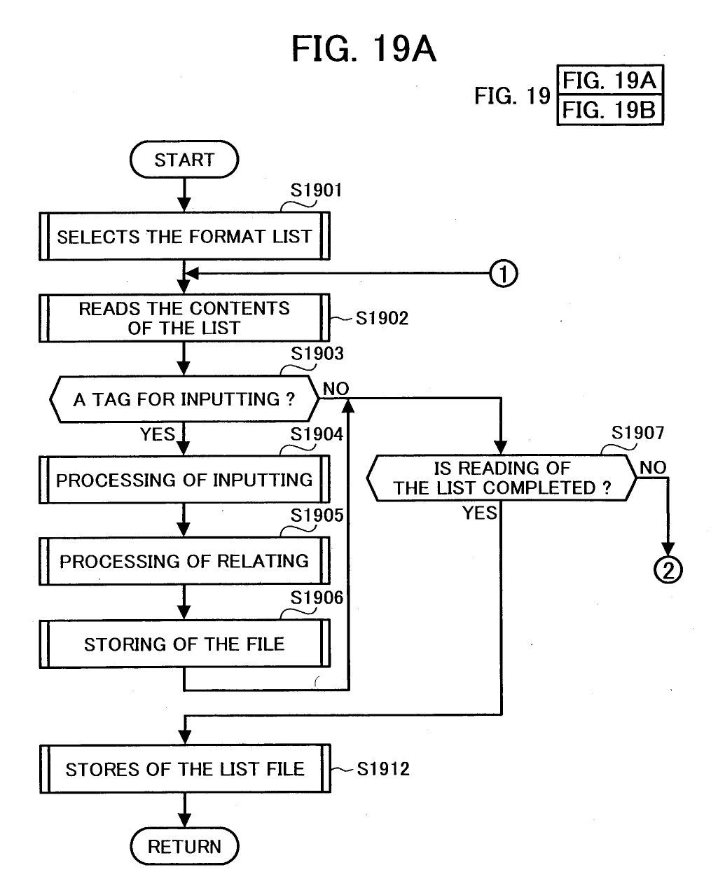

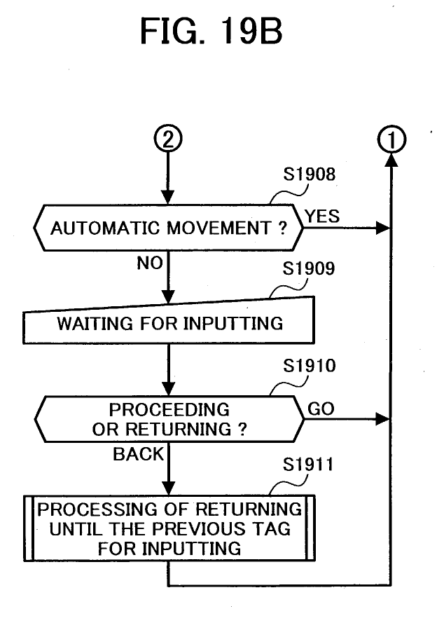

In the following, there will be described details of a processing for the input operation according to the fourth embodiment using a flow chart illustrated in FIG. 19. First, the processing section 131 displays a screen for guidance for the operation on a liquid crystal display section 161 in the display section 102. An operator selects a format list while observing the display screen in step S1901. Then, the processing section 131 reads a selected format list in step S1902 to detect whether or not the tag for inputting is existent in step S1903. When the tag for inputting is finished (No in step S1903), the operation proceeds to step S1907.

When the tag for inputting is detected (Yes in step S1903), a corresponding processing for inputting is executed in step S1904. Then, respective files subject to the processing for inputting are related in the order of the reading for the list following identifiers to fill the list in step S1905. The input files are stored in order in the recording section 105 in step S1906.

Thereafter, when the reading for the format list is not entirely complete (No in step S1907), it is detected whether or not the proceeding is automatic in step S1908. The automatic proceeding is set in a setup mode in an initial menu, where the proceeding to the next contents on the list (tag for inputting) can be set to be automatic/manual in conformity with the contents of the description in HTML.

When a choice is made of the automatic proceeding (Yes in step S1903), the operation returns to step S1902 and reads the next contents on the list. In contrast, when a choice is made of the manual proceeding (No in step S1908), the operation waits for the operation for inputting in step S1909.

The operation for inputting by an operator can select a movement “proceeding” to the next contents on the list or a movement “returning” to the previous contents on the list.

The selection is achieved by the operation for a movement key (not shown) provided in the operation section 106. When the selection is “proceeding” (proceeding in step S1910), the operation returns to step S1902 When the selection is “returning” (returning in step S1910), the operation returns to the previous contents of the format list (tag for inputting), and in this state the operation returns to step S1902 where the previous contents of the list are read again.

When the format list is completely read (Yes in step S1907), a completed format list is stored in the recording section 105 in step S1912, resulting in the end of the operation.

When the contents (tag for inputting) of the format list are set to be automatically moved, the operation successively automatically changes to an input mode corresponding to the contents of the format list, and an operator can successively smoothly achieve inputting of multimedia simply following guided procedures. In contrast, when the contents of the format list are set to be manually moved, the operation for inputting is ensured while successively checking the input mode. Further, the previous operation for inputting can be again executed to facilitate the correction for mistaken inputting.

Fifth Preferred Embodiment

A fifth preferred embodiment is adapted such that a format list is incorporated into the digital camera apparatus 100, on the basis of which format list input data stored in the digital camera apparatus 100 is in turn regenerated and displayed. In the digital camera apparatus 100 there are stored various input data (still image, animation, text input, etc.) inputted into an external memory medium previously mounted on the recording section 105 or the card slot section 108. For the regeneration a choice is possible between automatic regeneration or manual regeneration.

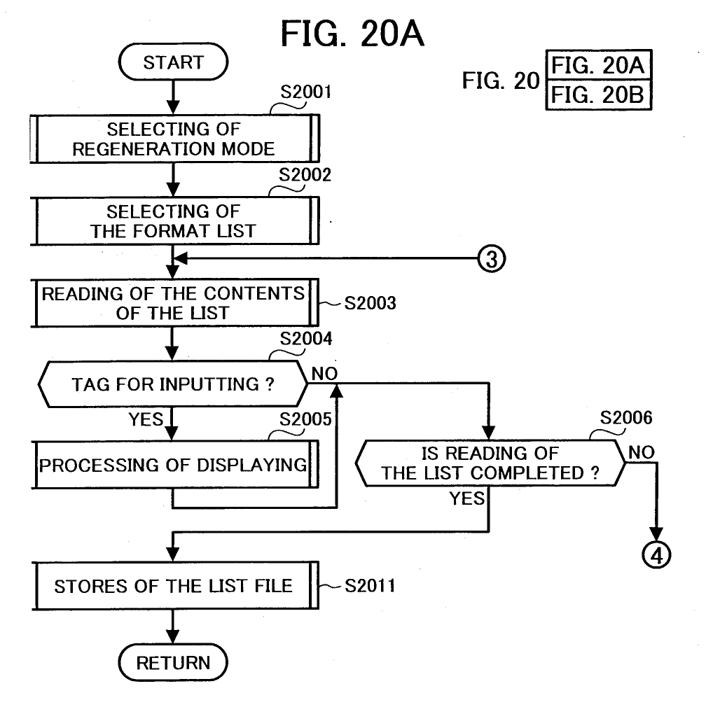

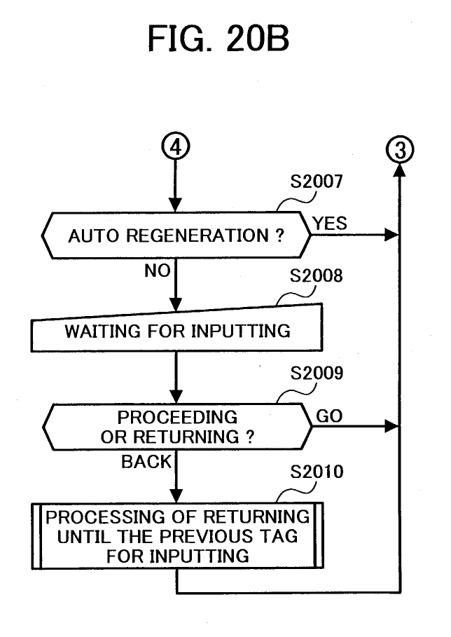

Referring to FIG. 20, a flow chart for illustrating the contents of a processing of the foregoing regeneration function (regeneration mode) is provided. An operator first operates a mode dial (not shown) provided on the operation section 106 to select the regeneration mode for regenerating input data in step S2001. The processing section 131 displays a screen for guidance for operation incorporated on the liquid crystal display section. 161 in the display section 102. An operator selects the format list while observing the display screen. In step S2002.

Then, the processing section 131 reads a selected format list in step S2003, and detects whether or not the tag for inputting is existent in step S2004. When the tag for inputting is detected (Yes in step S2004), a processing is executed, which displays input data recorded corresponding to the tag for inputting on the display section 102 in step S2005. The input data displayed thereupon involves photographing a still image, recording a voice, photographing an animation, and inputting of a text, etc., already stored in the recording section 105 (or an external memory medium mounted on the card slot section 108).

When the tag for inputting is finished (No in step S2004), and after the processing for displaying in step S2005 is executed, it is detected whether or not reading of the list is completed in step S2006. In the time interval the reading for the list is not complete (No in step S2006), the processing for regeneration described below will be continued.

It is first detected whether or not the operation is automatic regeneration in step S2007. The automatic regeneration is previously set in a setup mode for an initial menu, in which a movement to the next contents of the list (tag for inputting) can be set automatically or manually based upon the contents of the description in HTML.

When a choice is made of the automatic movement (Yes in step S2007), the operation returns to step S2003 to read the next contents of the list. In contrast, when a choice is made of the manual movement (No in step S2007), the operation waits for inputting of the operation in step S2008.

The inputting for the operation by an operator can select the next contents of the list (a movement “proceeding” to displaying or a movement “returning” to the previous contents of the list) can be selected. The selection is achieved by the operation of a movement key (not shown) provided on the operation section 106. Herein, when the selection is “proceeding” (proceeding in step S2009), the operation returns to step S2003. When the selection is “returning” (returning in step S2009), the operation returns to the previous contents of the format list in step S2010, and in this state returns to step S2003 to again read the previous contents of the list. When the reading of the format list is entirely complete (Yes in step S2006), the format list is stored in the recording section 105 in step S2011, resulting in the end of the operation.

In accordance with the aforementioned regeneration processing, the input data can he automatically regenerated, and it is easily checked that the stored input data partly lacks or leaks. Further, a movement direction of the regenerated and displayed contents can be fed/returned to display a necessary position in a simplified manner.

Sixth Preferred Embodiment

In what follows, there will be described the arrangement of a sixth preferred embodiment of the present invention. In the present embodiment, the processing section 131 analyzes the contents of the format list, and when the operation changes to an input mode corresponding to a result of he analysis, the contents of the operation of inputting is guided to a user in a more concrete manner.

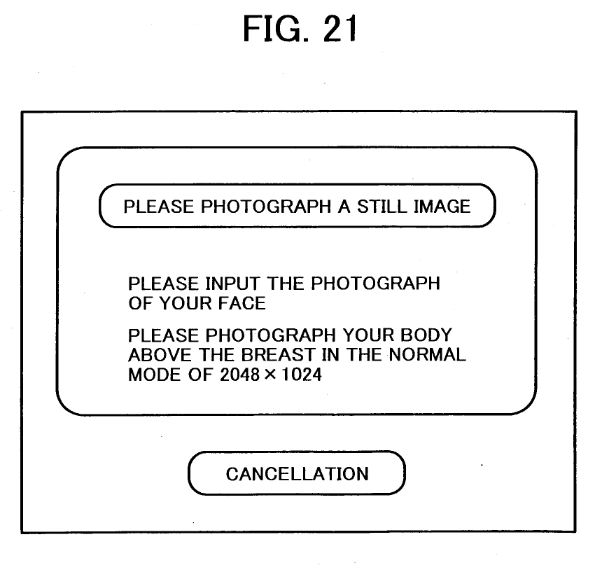

For example, on the display section 102 an input mode and instructed contents judged by the analysis for the tag are displayed as illustrated on a screen of guidance in FIG. 21, which guide and indicate contents to be operated for inputting for an operator with the aid of a still image, an animation, a voice, and characters. Hereby, an operator can achieve a proper input operation without causing any error while observing the contents displayed on the display section 102. Herein, the contents for guidance illustrated in FIG. 21 correspond to the position of the description in the first embodiment (the tag for inputting concerning photographing of a still image in the format list in FIG. 2).

Seventh Preferred Embodiment

In what follows, a seventh preferred embodiment of the present invention will be described. In the present embodiment, the processing section 131 analyzes the contents of the format list to guide list information for inputting such as the number of items to be inputted and lists of items before transition to the input mode.

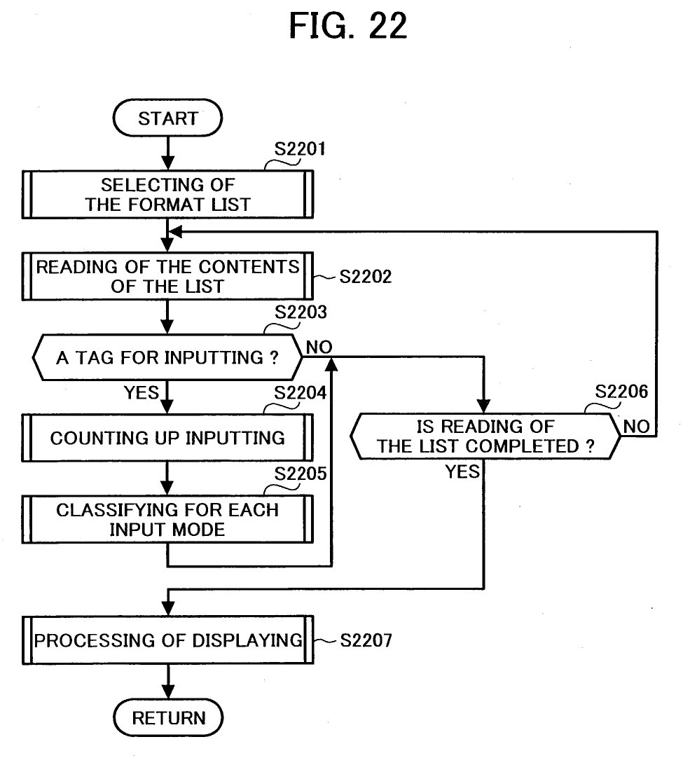

Referring to FIG. 22, a flow chart illustrating the contents of a processing associated with guidance and display for the input information for the list is provided. Each processing described below is adapted to be automatically executed after the format list described in the aforementioned embodiments is read and before data in the respective input modes are inputted, and further are adapted to be guided and indicated upon reading the format list after a mode dial (not shown) provided on the operation section 106 is operated and is switched to an edit mode.

The processing section 131 first displays a screen for operation and guidance on a liquid crystal display section 161 in the display section 102. An operator selects the format list while observing the screen for display in step S2201. Then, the processing section 131 reads a selected format list in step S2202, and detects whether or not the tag for inputting is existent in step S2203. When the tag for b inputting is finished (No in step S2203), the operation proceeds to step S2206.

When the tag for inputting is detected (Yes in step S2203), an input count is incremented by 1 and is held in step S2204. The input count corresponds to the total number of the tags for inputting (the number of total inputs) described on the format list. Next, the input counts are classified for every mode in step S2205. The classification involves the respective contents of multimedia inputs, i.e., photographing of a still image, recording of a voice, photographing of an animation, and inputting of a text, and the number of counts for each classification is stored.

During a time interval the reading of the format list is completed (No in step S2206), the operation returns to step S2202 to repeatedly process the foregoing contents. When the reading of the list is completed (Yes in step S2206), the foregoing information of the list inputs (the total number of inputs, and the number of the inputs for each classification) is guided to and displayed on he display section 102 in step S2207, resulting in the end of the operation.

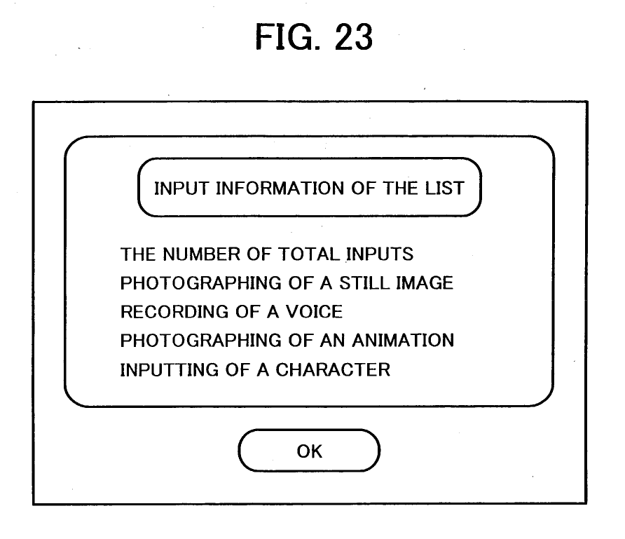

Referring to FIG. 23, an example of displaying the information of inputting of the list displayed on the display section 102 is illustrated. As illustrated in the figure, the number of the total items to be inputted and the number of inputs for each classification (photographing of a still image, recording of a voice, photographing of an animation, inputting of characters) are displayed as a list. With the list an operator can grasp the total number input operations required in the input mode and the number of items for each classification with ease.

Eighth Preferred Embodiment

In what follows, the arrangement of an eighth preferred embodiment will be described. In the present embodiment, the processing section 131 analyzes the contents of the format list to previously display to an user an image which is obtained by developing the format list to be inputted.

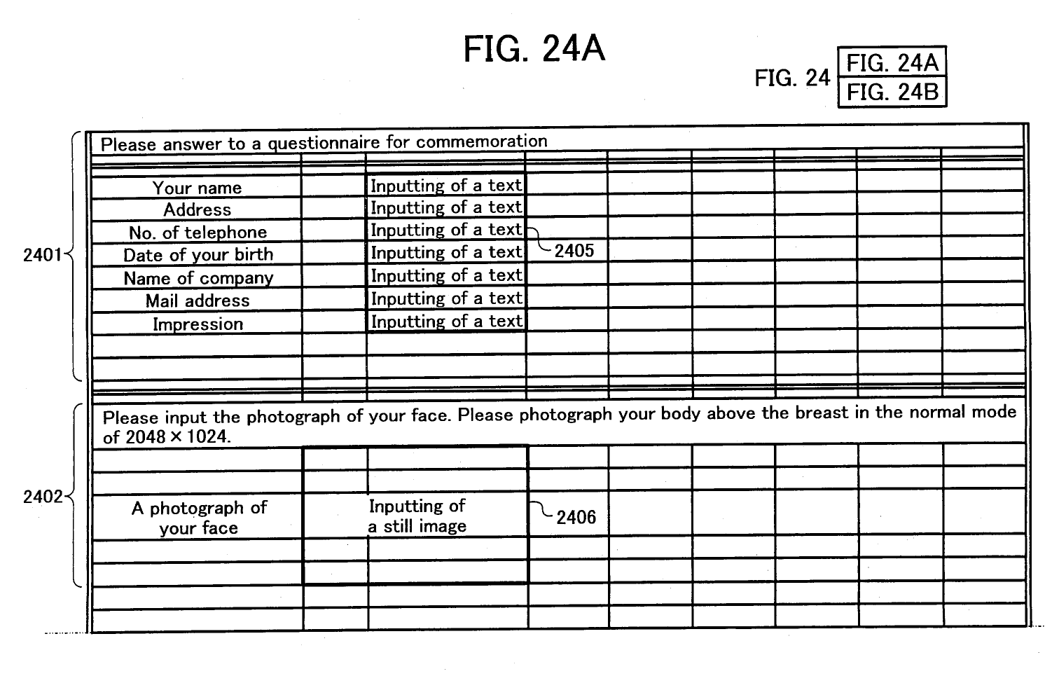

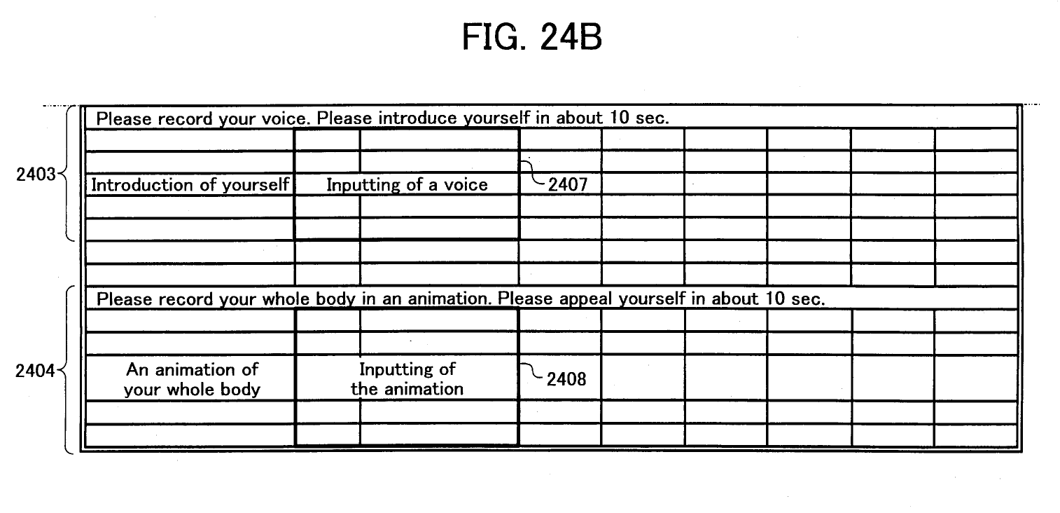

Referring to FIG. 24, a view exemplarily illustrating as an image, a format list displayed on the display section 102 is provided. As described in the aforementioned embodiments, when the format list is described in the format of HTML, the processing section 131 develops as an image the format list in an application such as a brauzer as illustrated in the figure.

Herein, the brauzer has a function of displaying, for each input item before being inputted by an operator, of replacing the item by a predetermined image in a dummy fashion and displaying for understanding of each input mode. For this, respective display items of respective input tag portions (guide sentences 2401 to 2404) are displayed with characters, and at portions of input items 2405 to 2408 corresponding to each guide sentence 2401 pseudo-images are displayed for guiding the input positions and the contents.

For example, since input items 2405 are inputs of text characters corresponding to a name, an address, etc., respectively, they are displayed as “TEXT inputs”. Since the input item 2406 is an input of a still image of a face photograph, a frame where an image input is required and characters “an input of a still image” are displayed. Hereby, an operator reads the guide sentences 2401 to 2404, and are informed of necessary input operations with ease with the aid of displays of the respective input items 2405 to 2408.

It is herein noticed that after the input operations in the input modes respectively corresponding to the input items 2405 to 2408, characters and images, etc., corresponding to the input operations may be displayed at portions of the input items 2405 to 2408. Without limiting thereto, marks and icons indicative of “already inputted” may be displayed.

Ninth Preferred Embodiment

In what follows, the arrangement of a ninth preferred embodiment according to the present invention will be described. In the present embodiment, an exclusive tag capable of setting input conditions in each input mode is described on the format list, whereby the operation changes to a corresponding input mode obtained by analyzing the contents of an incorporated format list. To automatically set input conditions indicated by the exclusive tag by detecting the exclusive tag.

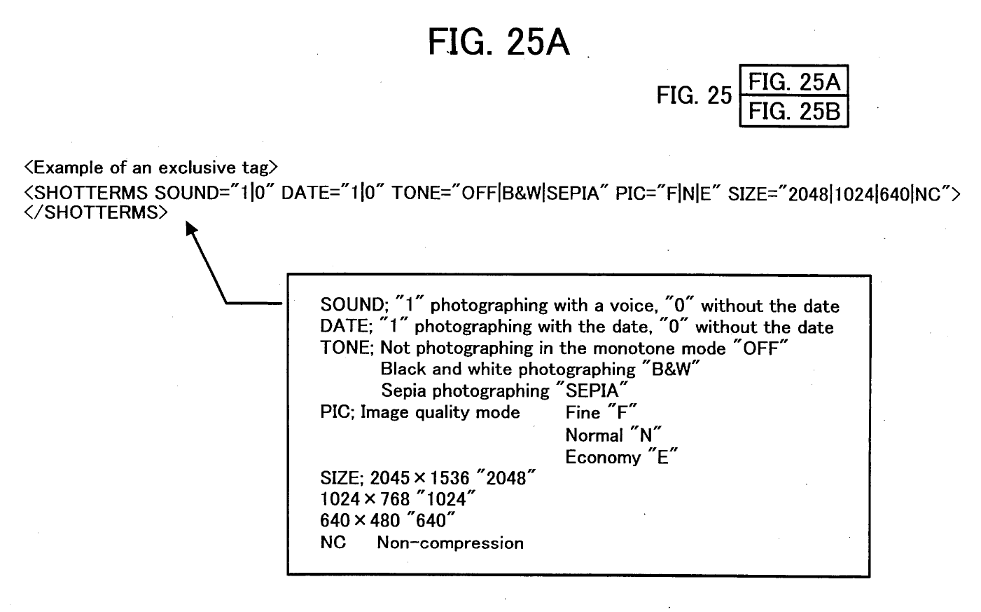

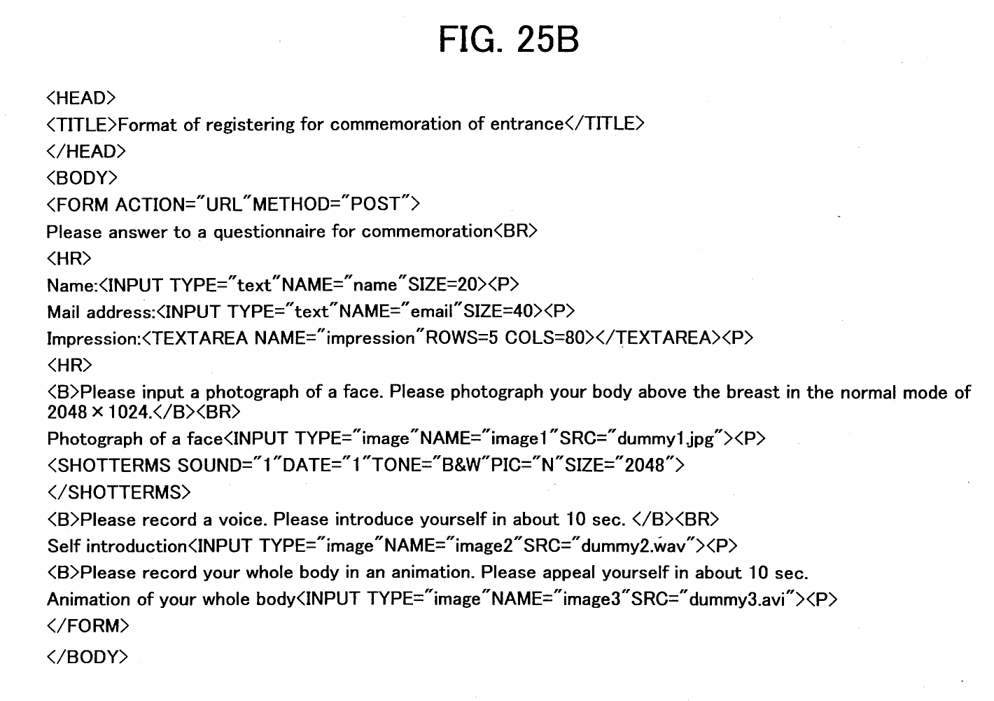

Referring to FIG. 25, an example of the format list is illustrated. On the format list, an exclusive tag for setting input conditions to determine the input mode is described. In the illustrated example, for an external tag (SHOTTERMS) input conditions (conditions of photographing) of a still image is attached to the head of the format list.

For the conditions of photographing, it is possible to set the presence of photographing with a voice (SOUND), the presence of photographing with the date (DATE), the presence of photographing in a monotone mode (TONE), image quality mode (PIC), and an image size (SIZE).

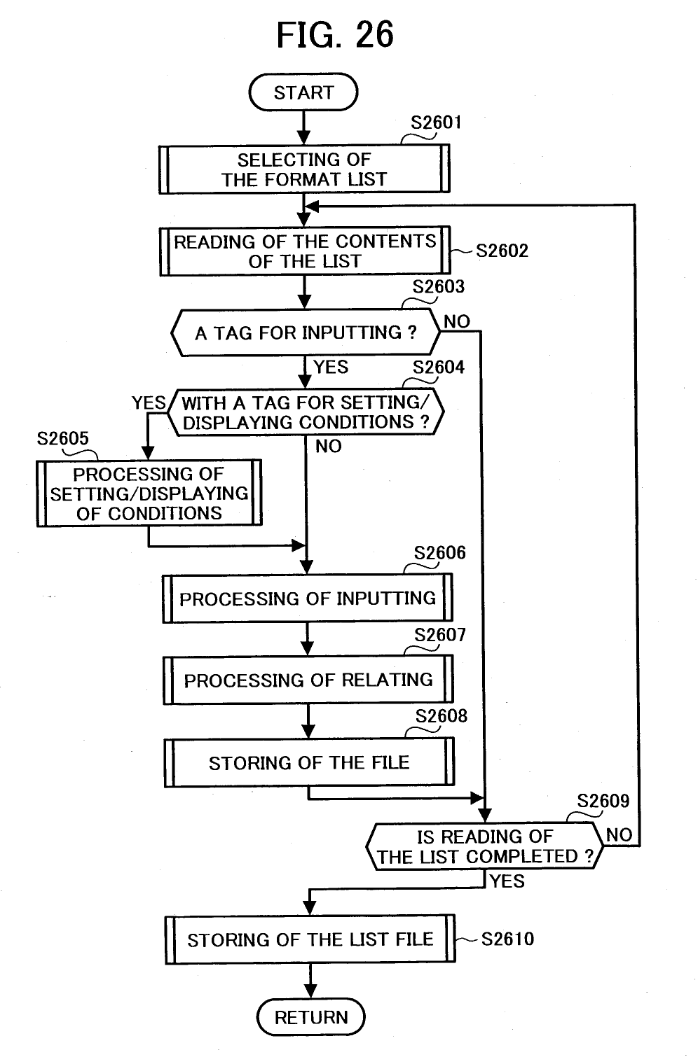

Referring to FIG. 26, a flow chart illustrating a processing of automatic setting for input conditions by the detection of the exclusive tag is provided. The processing section 131 displays a screen for guidance for operation on the liquid crystal display section 161 in the display section 102. An operator selects the format list while observing the display screen in step S2601. Then, the processing section 131 reads a selected format list in step S2602 to detect the presence of a tag for inputting in step S2603. When the tag for inputting is finished (No in step S2603), the operation proceeds to step S2609.

Although when the tag for inputting is detected (Yes in step S2603), a processing of inputting which changes to an input mode corresponding to the tag for inputting is executed, upon detection for the exclusive tag input conditions in the respective input modes are automatically set. For the format list, the exclusive tag is to be described at the heat of the format list, and the processing section 131 detects the presence of the exclusive tag in the stage of step S2602.

When the exclusive tag is detected (Yes in step S2604), the input conditions in the aforementioned example set to the exclusive tag are automatically set in step S2605, and when the exclusive tag is not detected (No in step S2604), the input conditions are not automatically set. Subsequently, a processing of inputting by an operator (any among photographing for a still image, recording for a voice, photographing for an animation, and inputting for a text) is executed in step S2606.

Then, the respective files subject to the processing of inputting are related in the order of reading for the list with identifiers to fill the list in step S2607. The input files are stored in the recording section 105 in succession in step S2608, and the operation returns to step S2602 to repeatedly process the foregoing contents until the reading for the list is complete (No in step S2609). When the reading for the list is completed (Yes in step S2609), the complete format list is stored in the recording section 105 in step S2610, resulting in the end of the operation.

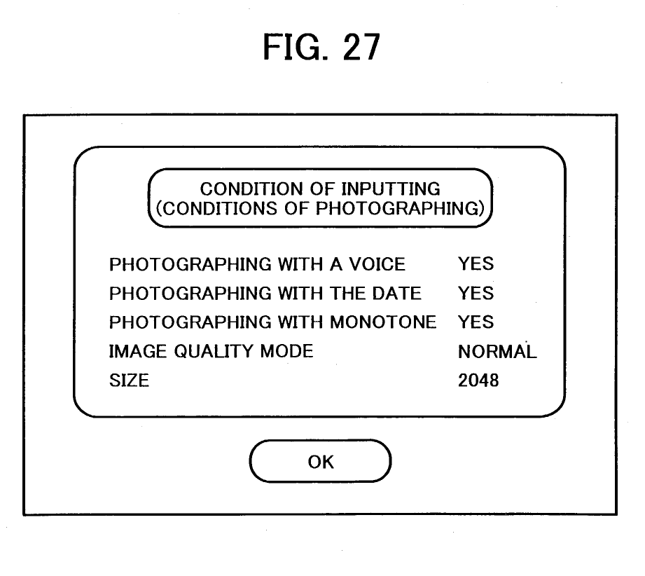

Herein, the conditions of inputting (conditions of photographing) set automatically are displayed on the display section 102. Referring to FIG. 27, a view illustrating a display example for conditions of photographing upon photographing of a still image is provided. As illustrated in then figure, the respective conditions of photographing set automatically are displayed on the display section 102.

The conditions of inputting (conditions of photographing) can be automatically set by providing an exclusive tag for setting of input conditions on the format list, and analyzing the exclusive tag, and the need of setting work upon photographing and so on can be eliminated or sharply simplified to make the input operation simple, as described above. Further, an erroneous operation can be prevented by displaying the conditions of inputting set automatically on the display section 102 and informing a user thereof.

Tenth Preferred Embodiment

In what follows, the arrangement of a tenth preferred embodiment will be described. In the present embodiment, there is switchable execution or non-execution of automatic setting for conditions of inputting indicated by an exclusive tag for every characteristics of an input function possessed by the apparatus and for each attribute of a user upon detection of the exclusive tag described in the ninth embodiment. It is possible to previously register characteristics such as an input function possessed by the apparatus and attributes such as the need or non-need of the input processing for every user in the recording section 105 in the apparatus. The apparatus is further adapted free to he set upon the operation or to be altered.

The processing section 131, after detecting the exclusive tag upon analyzing the contents of the incorporated format list, switches the automatic setting for conditions for inputting indicated by the exclusive tag in response to the characteristics of the input function and the like of the apparatus and attributes of a user partly or wholly and effectively/non-effectively.

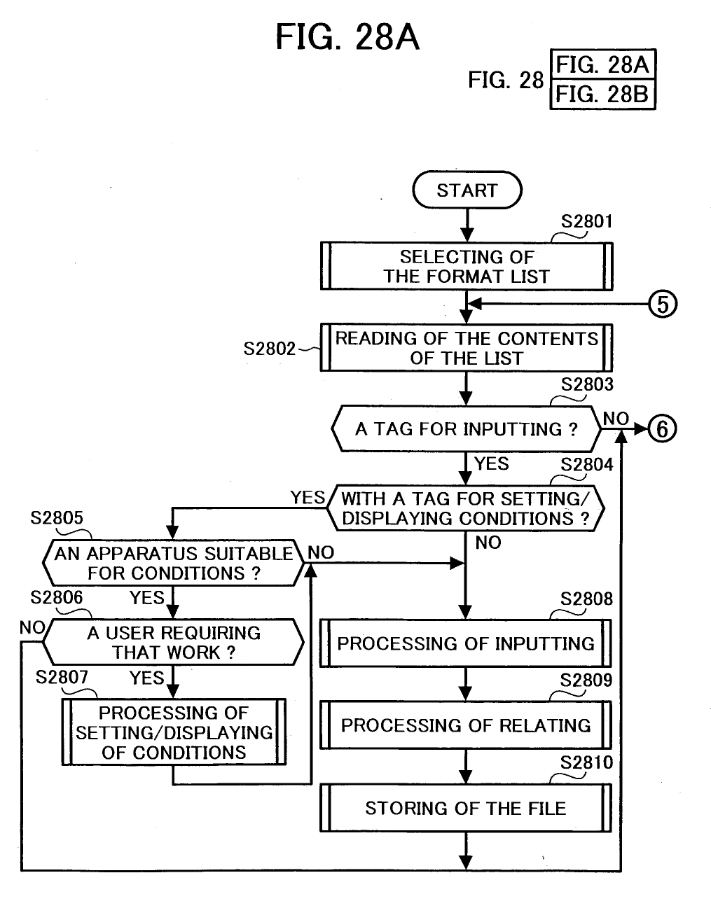

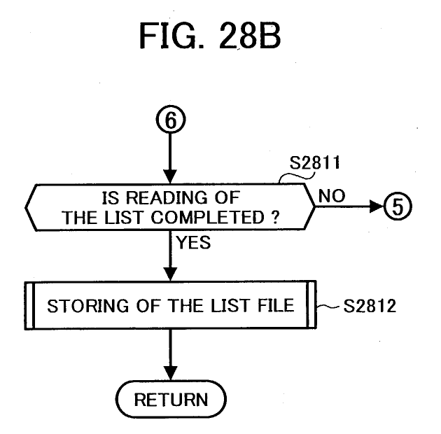

Referring to FIG. 28, a flow chart illustrating the contents of switching of valid/invalid of the automatic setting for conditions of inputting owing to the detection of the exclusive tag is provided. The processing section 131 displays a screen for operation and guidance on the liquid crystal display section 161 in the display section 102. An operator selects the format list while observing the display screen in step S2801. Then, the processing section 131 reads a selected format list in step S2802 to detect whether or not the tag for inputting is existent in step S2803. When the tag for inputting is finished (No in step S2803), the operation proceeds to step S2811.

When the tag for inputting is detected (Yes in step S2803), it is ten judged whether or not the exclusive tag is existent in step S2804). When the tag fir inputting is detected (Yes in step S2804), a switching processing is executed, in which the automatic setting for the conditions of inputting in each input mode is made valid or invalid.

First the input function possessed by the apparatus is read from the recording section 105 to judge whether or not the apparatus is one suitable for the conditions of inputting indicated by the exclusive tag in step S2805. For example, it is judged whether or not the apparatus possesses a function where automatic setting of the conditions for inputting described on the format list is possible When the apparatus is suitable for the conditions of inputting (Yes in step S2805), the operation then proceeds to a judgment for the attributes of a user in step S2806, while when the apparatus is one not suitable for the conditions of inputting (No in step S2805), the operation proceeds to the input processing in step S2808 (followed by the manual setting for the conditions of inputting).

As illustrated in FIG. 25, the exclusive tag is to be described at the bead of the format list, and it is detected for the processing section 131 whether or not the exclusive tag is existent in the stage of step S2802.

In the judgment for the attributes of a user in step S2806, the attributes of an operator are obtained by the reading from the recording section 105 or the setting by the operator to judge whether or not the user is a user suitable for the conditions of inputting indicated by the exclusive tag. For example, it is judged whether or not the user is a user requiring the automatic setting of the conditions of inputting described in the format list or a user requiring the processing of inputting for every tag of inputting.

When the user is judged to be an operator requiring the processing of inputting for the tag for inputting with the aid of the judgment for the attributes of a user (Yes in step S2806, the conditions of inputting set to the exclusive tag are automatically set in step S2607, or when the user is judged to be an operator not requiring the processing of inputting for the tag for inputting (No in step S2806), the operation proceeds to step S2811 without performing the processing for inputting itself.

After the state where the conditions of inputting are automatically set in the processing in step S2807 or the exclusive tag is not detected in the processing in step S2807 (No in step S2804), and the automatic setting for the conditions of inputting is not executed, the processing of inputting (any of photographing for a still image, recording for a voice, photographing for an animation, and inputting a text, etc.,) by an operator is executed in step S2808.

Successively, the respective files subject to the conditions of inputting are related in the order of the reading for the list with the aid of identifiers to fill the list in step S2809. The input files are stored in order in the recording section 105 in step S2810. Thereafter, during the time interval the reading for the list is completed (No in step S2811) the operation returns to step S2802 to repeatedly process the foregoing contents. When the reading for the list is completed (Yes in step S2811), a complete format list is stored in the recording section 105 in step S2812, resulting in the end of the operation.

In accordance with the aforementioned processing, the need or non-need of the processing for inputting, and the automatic setting for the conditions of inputting (conditions of inputting), etc., can be switched depending upon the characteristics such as a function of the apparatus registered in the apparatus, and the attributes of a user. Hereby, setting of different conditions of inputting, and guidance and display are ensured in a different digital camera apparatus 100 while employing a single format list for assurance of an improvement of convenience of the apparatus and generalization of the format list.

Eleventh Preferred Embodiment

In what follows, the arrangement of an eleventh preferred embodiment of the present invention will be described. In the present embodiment, a transmission destination in a communication mode is described as an exclusive tag on the format list, and conditions of transmission for every transmission destination previously set in the apparatus are automatically set by the analysis for the format list. The digital camera apparatus 100 is adapted such that a format list completed with input data subject to the processing for inputting can be transmitted to external various servers through a communication processing section 136.

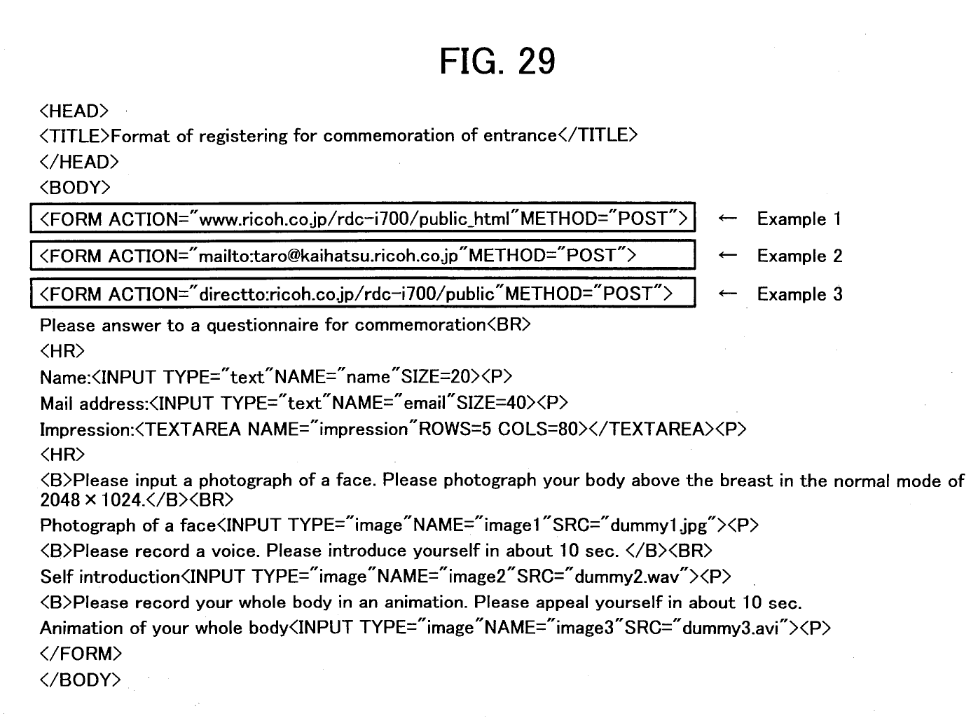

Referring to FIG. 29, a view illustrating a format list on which automatic setting for a transmission destination and conditions of transmission is described is provided. As illustrated in the figure, a description concerning the setting for each server as described in examples 1 to 3 is provided in a portion of setting for the transmission destination (FORM ACTION) as the exclusive tag.

In example 1, the transmission destination is described with an URL address. The digital camera apparatus 100 internally sets input data to a server name at the URL address (ricoh.co.jp) and to a folder name (/rdc-i700/public-html), and conditions of transmission for uploading input data to an FTP server.

In example 2, the transmission address is described with a mail address (mailto:taro@kaihatsu.ricoh.co.jp). The digital camera apparatus 100 internally sets conditions of transmission where a completed format list is transmitted to a mail server at the mail address as an attached file to the mail.

In example 3, a server name (ricob.co.jp) of a direct transfer destination to an external PC such ass a personal computer, and a folder name (rdc-i700/public) are described. The digital camera apparatus 100 internally sets conditions of transmission where a completed format list is transmitted to the server.

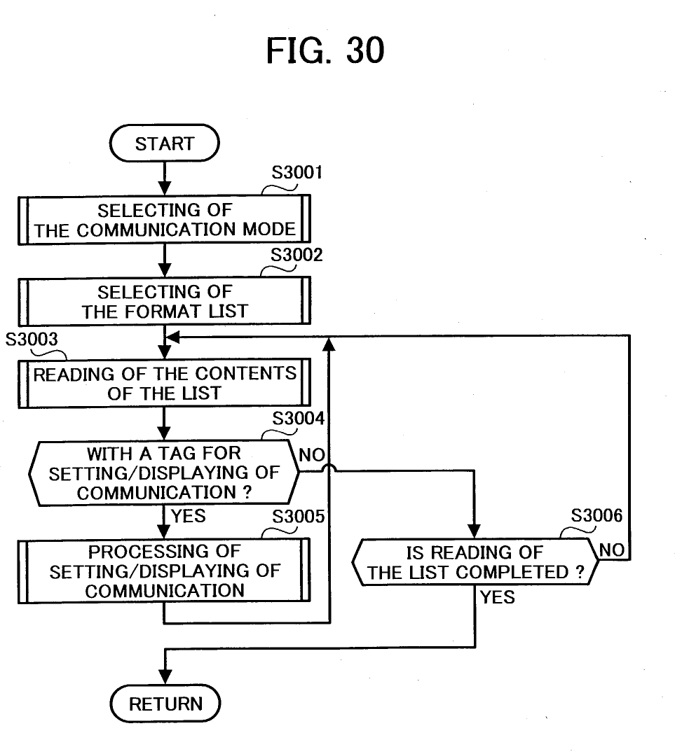

Referring to FIG. 30, a flow chart illustrating the processing for automatic setting for conditions for transmission upon a transmission mode is provided. First, an operator operates a mode dial (not shown) provided on the operation section 106 to select a transmission mode for transmitting input data in step S3001. The processing section 131 displays a screen for operation and guidance incorporated on the liquid crystal display section 161 in the display section 102. The operator selects the format list while observing the display screen in step S3002.

Then, the processing means 131 reads a selected format list in step S3003 to detect an exclusive tag (FORM ACTION) set for transmission associated with communication in step S3004. When the exclusive tag for setting the destination of transmission is detected (Yes in step S3004), corresponding conditions of transmission are set for each destination of transmission, which set conditions of transmission is processed to be displayed on the display section 102 in step S3005, and further the operation returns to step S3003 and searches the next destination of transmission.

When the detection for the exclusive tag set for transmission associated with communication is finished (No in step S3004), it is detected whether or not the reading for the format list is completed in step S3006. During the time interval the reading for the list is not completed (No in step S3006), the operation returns to step S3003 to repeat the same processing. When the reading for the format list is completed (Yes in step S3006), the setting for the conditions for transmission is finished.

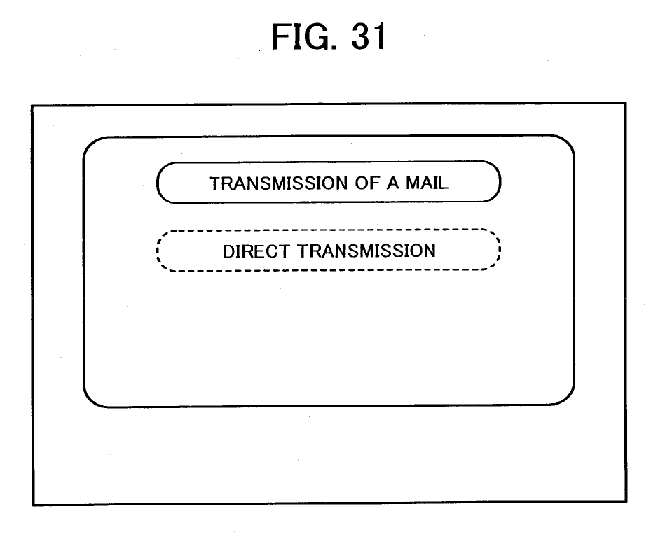

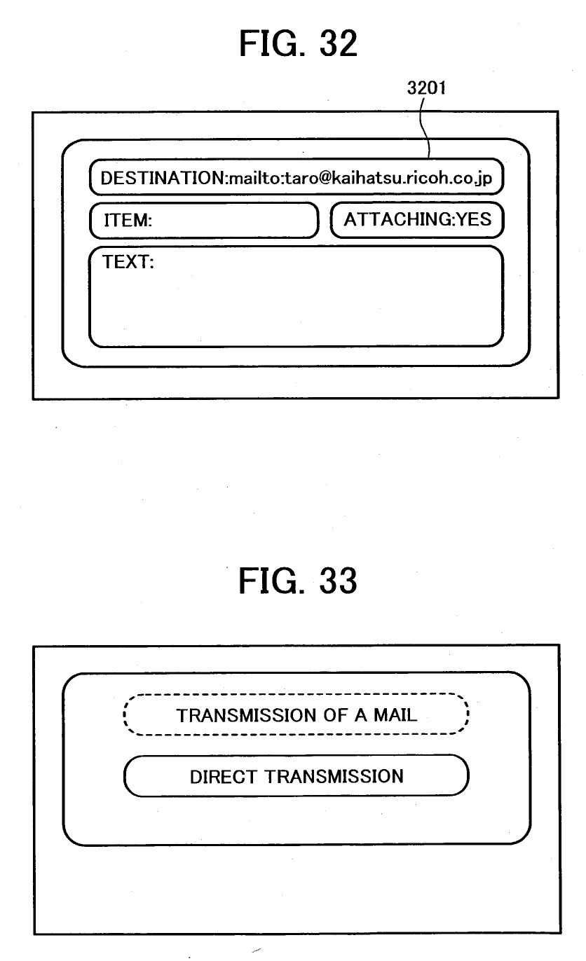

Referring to FIG. 31, a view illustrating the contents of display upon setting for transmission using an electronic mail is provided. When after the transmission mode is set with the mode dial a mail server is set to the incorporated format list, the screen for transmission of a mail is selectable as illustrated in the figure, and a screen for preparation for an electronic mail is displayed with depression of a check key as illustrated in FIG. 32.

On the screen for preparation a screen for inputting such as a destination, a title, a text is displayed, and to the portion of destination item 3201 a mail address described on the format list is automatically inputted. It is here possible to manually alter the mail address after the automatic preparation. Hereby, the processing section 131 executes the processing of attaching of a completed format list to the mail, and executes the processing of transmission to the mail address through the communication processing section 136.

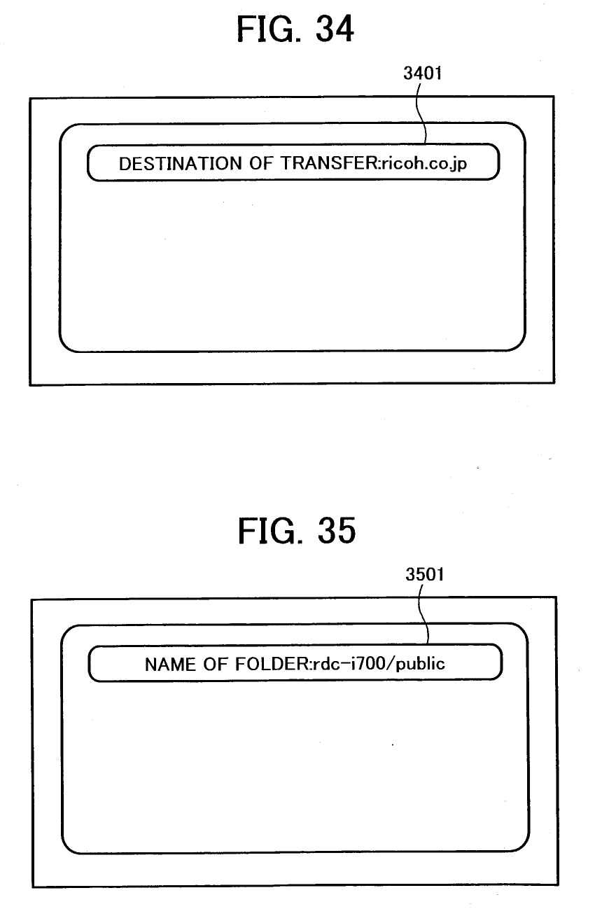

Referring to FIG. 33, a view illustrating the contents of display upon setting the direct transmission to the PC is provided when after the communication mode is set with the mode dial, a transmission destination server of the direct transmission to the PC is set to the incorporated format list, the screen for the direct transmission is selectable as illustrated in the figure, and the item 3401 for the transmission is displayed with the depression of the check key as illustrated in FIG. 34. After the destination of transmission is checked, the transmission destination folder item 3501 of the destination of transmission (PC) is displayed as illustrated in FIG. 35.

For names of a server and a folder in the transmission destination (PC) there are automatically inputted a server name and a folder name described on the format list. It is here possible to manually alter the destination of transmission after the automatic preparation. Hereby, the processing section 131 executes the processing of direct transmission of a completed format list to the PC, and executes the processing of transmission to the server destination through the communication processing section 136.

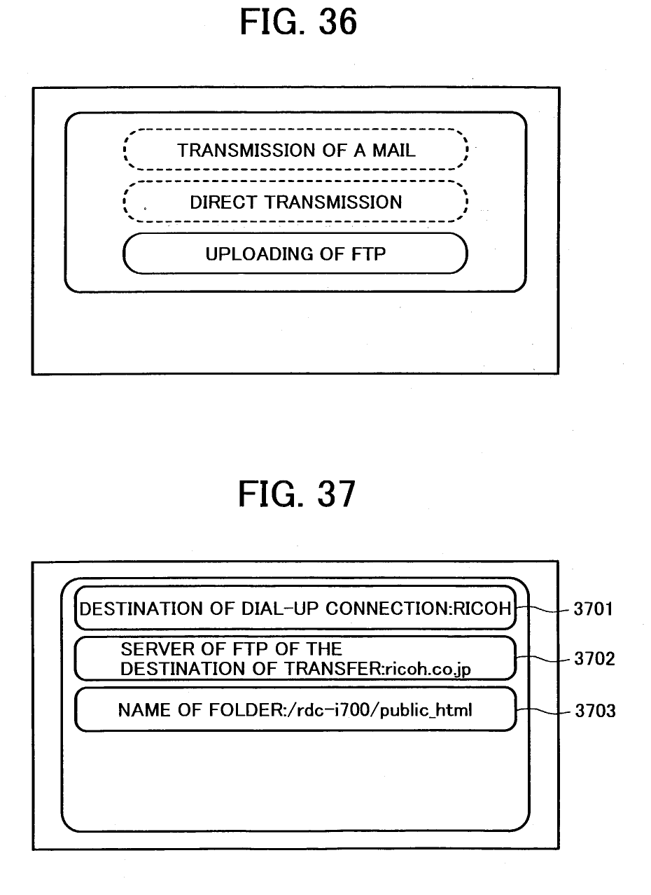

Referring to FIG. 36, a view illustrating the contents of display upon uploading to the FTP server is provided. When after the communication mode is set with the mode dial, an URL address of the FTP server is set to the incorporated format list, the screen of transmission of FTP uploading is selectable as illustrated in the figure, and the item 3701 of the destination of dial-up connection, the item 3702 of the FTP server, and the item 3703 of the transmission destination folder are displayed with the depression of the check key as illustrated in FIG. 37.

For Names of an FTP server and a folder in the destination of transmission an URL address described on the format list is automatically inputted, as described above. It is here possible to manually alter the destination of transfer after the automatic preparation. Hereby, the processing section 131 executes the processing of FTP uploading of a completed format list to the FTP server, and executes the processing of transmission to the FTP server through the communication transmission section 136.

In accordance with the present invention, as described above, the setting of the conditions of transmission can automatically be set for every destination of transmission, the destination of transmission and the conditions of transmission can be set without any error, and the need of setting of a completed format list associated with the transmission is eliminated. Hereby, the operation property is sharply improved. As the format list there is employed one where he format list is described in the format of HTML described previously, whereby on the side of an external apparatus an updated (completed) format list transmitted from the digital camera apparatus 100 can be utilized as being directly described on the Web of the Internet.

Further, in accordance with the present invention, on the side of an external apparatus required input data can be obtained with the aid of the format list after the completion from the side of the digital camera apparatus 100 only by sending the format list requiring the necessary input data to the digital camera apparatus 100, and on the basis of the format list input data obtained in the digital camera apparatus 100 can be utilized.

Although in the respective embodiments described above the digital camera apparatus 100 was exemplarily employed as a concrete example of the input apparatus for image according to the present invention, a digital camera-equipped PDA, a notebook personal computer, and the like can be employed as the input apparatus for image of the present invention.

What is claimed is:

1. An input apparatus for image comprising:
recording means for previously incorporating and recording a format list in which there are described the procedures of an operation of inputting employing selectively a plurality of different input functions possessed by the input apparatus for image by an external apparatus such as a personal computer and the like;
processing means for analyzing the contents of the description of the incorporated format list, selecting an input function corresponding to a result of the analysis to transfer it to a corresponding input mode, and displaying and outputting the contents of the operation of inputting in said input mode;
display means for displaying said selected input mode; and
operation means for executing an operation of inputting of data based upon the input mode displayed on said display means.

2. An input apparatus for image according to claim 1, wherein said plurality of the input functions are to input still pictures, voices, animations, and characters, and
said processing means changes to a corresponding input mode among photographing of a still image, recording of a voice, photographing of an animation, and inputting of a text corresponding to a selected input function, and displays and outputs said input mode on/to said display means, and executes the operation of inputting of data in said input mode.

3. An input apparatus for image according to claim 2, wherein said processing means updates and records the data obtained by the operation of inputting in said changed input mode while relating said data to the corresponding position of the description of the format list recorded in said recording means.

4. An input apparatus for image according to claim 3, wherein said processing means relates attached information such as the conditions of recording of data obtained with the operation of inputting in said changed input mode, and file attributes with said data to update and record said format list.

5. An input apparatus for image according to claim 3, wherein in said recording means data such as images and characters concerning attributes of the apparatus and a user can be inputted and stored, and
said processing means analyzes the description contents of the description of said incorporated format list, selects an input function corresponding to an analyzed result to change the operation to a corresponding input mode, and displays and outputs the input operation in said input mode, and further when the contents of the description of the format list indicates an input of the attributes of said stored apparatus and a user, reads the attribute data of the apparatus and the user from said recording means, and writes them at the corresponding position of description and updates and records said format list.

6. An input apparatus for image according to any one among claims 1 to 5, wherein said format list is described in the format of an HTML having a plurality of tags for inputting, and
said processing means analyzes the contents of the description of the corresponding tag for inputting described in said format list, and selects an input function corresponding to a result of the analysis to transfer the operation to a corresponding input mode, and further displays and outputs an operation of inputting in said input mode and describes data inputted in said input mode at a corresponding portion of a tag for inputting of said format list in the form of the HTML.

7. An input apparatus for image according to any one among claims 1 to 6, wherein said processing means analyzes the contents of the description of said tag for inputting in said incorporated format list, and selects an input function corresponding to a result of the analysis to change the operation to a corresponding input mode, and every time an input operation in said input mode is detected, analysis for the contents of the description of the next tag for inputting in said format list is executed to successively change the operation to a corresponding input mode.

8. An input apparatus for image according to claim 7, wherein said processing means automatically executes, on the basis of set contents where any of automatic execution of said transition of said input mode or manual execution of the same is previously set, an analysis of the described contents of the tag for inputting of said format list and transition to a corresponding input mode upon setting of the automatic execution, while ensuring the manual execution of the transition of an input mode indicated by the next tag for inputting based upon operation selection by said operation means upon the setting of the manual execution.

9. An input apparatus for image according to claim 8, wherein said processing means, when the transition of said input mode is set to the manual execution, can arbitrarily select the execution of the analysis for the contents of the description of the next tag for inputting or the previous tag for inputting on said format list based upon the operation of inputting by said operation means.

10. An input apparatus for image comprising:
recording means for recording and storing a plurality of different input data recorded in the input apparatus for image;
processing means having a function of incorporating a format list on which the procedures of an input operation selectively employing a plurality of different input functions possessed by said input apparatus for image are described, and analyzing the contents of the description of a tag for inputting on said incorporated format list and automatically regenerating the input data recorded in said recording means corresponding to a result of the analysis in the order of the contents of the description of the tag for inputting in said format list; and
display means for displaying said selected input data.

11. An input apparatus according to claim 10, wherein said processing means is adapted such that said regeneration node can be set to manual execution, and upon setting of said manual execution a regeneration processing for input data indicated by the content of the description of the next tag for inputting or the previous tag for inputting on said format list based upon the selection of the operation of the operation means.

12. An input apparatus for image according to any one among claims 1 to 9, wherein said processing means, when the operation changes to a corresponding input mode as a result of the analysis for the contents of said incorporated format list, guides and indicates the contents of the necessary operation of inputting to said display means with a character and the like.

13. An input apparatus for image according to claim 12, wherein said processing means counts, upon analysis and execution for the contents of said incorporated formal list, the total number of the tags for inputting described on said format list and the number of the tags for every said input mode, and displays list input information of the total number of input items, the number of input items for every input mode, and the list of the items and the like on said display means.

14. An input apparatus for image according to any one of claims 12 and 13, wherein said processing means displays, upon analysis for the contents of said incorporated format list, an image obtained by developing said format list as an image on said display means and displays as an image the contents of the operation of inputting in a required input mode for every said tag for inputting described on the format list developed as the image

15. An input apparatus for image according to any one among claims 1 to 14, wherein on said format list an exclusive tag is described, in which tag the conditions of inputting such as conditions of photographing in each input mode can be set, and said processing means automatically sets the conditions of inputting indicated by said exclusive tag on the basis of the detection of the exclusive tag upon an analysis for the contents on said incorporated format list.

16. An input apparatus for image according to claim 15, wherein said processing
means displays the contents of said conditions of inputting automatically set on said display means.

17. Am input apparatus for image according to any one among claims 15 and 16, wherein in or to the apparatus characteristics such as an input function possessed by the apparatus and attributes of a user can be registered or set, and said processing means is, when said exclusive tag is detected upon the analysis of the contents of said incorporated format list, validly/invalidly switchable part or the whole of the automatic setting and the like for the attributes of a user and for the need or non-need of the input operation indicated by the exclusive tag in response to the characteristics of said apparatus such as a function of inputting and the attributes of a user.

18. An input apparatus for image according to any one among claims 1 to 17, wherein on said format list an exclusive tag is described, which tag can set a transmission destination of the input data subject to the operation of inputting,
the apparatus includes a communication processing section for transmitting said data of inputting subject to the operation of inputting to the outside, and
said processing means automatically sets, when the exclusive tag of said transmission destination is detected upon the analysis for the contents of said incorporated format list, the conditions of transmission for transmitting said data of inputting to said transmission destination.

19. An input apparatus for image according to claim 18, wherein said processing means sets, when said destination of transmission is a mail address, the conditions of transmission for transmitting an electronic mail to said mail address and attaching said data of inputting to said electronic mail.

20. An input apparatus for image according to claim 18, wherein said processing means automatically sets, when said destination of transmission is direct transmission to an external apparatus such as a personal computer, the computer name of said external apparatus and a transmission destination folder of said computer as said conditions of transmission.

21. An input apparatus for image according to claim 18, wherein said processing means automatically sets, when said destination of transmission is transmission for a file to an FTP server, the name of said FTP server and a transmission destination folder of said FTP server as said conditions of transmission.
